(19) United States
(12) Patent Application Publication
(10) Pub. No.: US 2009/0240760 A1
(43) Pub. Date: Sep. 24, 2009

(54) System and Method for Initiating Services

(75) Inventor: Anthony L. McDougle, Florence, AL (US)

Correspondence Address: LANIER FORD SHAVER & PAYNE P.C., P O BOX 2087, HUNTSVILLE, AL, 35804-2087, US

(73) Assignee: CONNECTALLSERVICES, INC., Florence, AL (US)

(21) Appl. No.: 12/052,250

(22) Filed: Mar. 20, 2008

(51) Int. Cl. H04L 9/00

(52) U.S. Cl. 709/201; 380/277

(57) ABSTRACT

A system of the present disclosure has a communication device that communicates with a service provider and logic that receives data identifying at least one subscriber and a property corresponding to the subscriber at which the subscriber desires service from the service provider. Further, the logic initiates service at the property based upon the data.

### BACKGROUND OF THE INVENTION

Owners of multi-family residential housing, e.g., apartments or condominiums, typically have a property management team comprising a leasing agent. The leasing agent is responsible for leasing the individual dwellings to a lessee.

When a lessee decides to lease an individual dwelling, the leasing agent ensures that all necessary paperwork has been executed. Once the paperwork has been executed, the lessee contacts one or more service providers, e.g., a utility company, a telephone company, a satellite television company, or the like, to subscribe to the provider's respective service.

### SUMMARY OF THE INVENTION

Generally, the present disclosure relates to a service initiation system and method. In particular, a system in accordance with an embodiment of the present disclosure allows a leasing agent, for example, to sign a lessee up for one or more services, e.g., utility services, telephone service, satellite television service, cable service, or the like, when the lessee executes his/her requisite paperwork.

A system in accordance with an embodiment of the present disclosure comprises a communication device for communicating with a service provider and logic configured to receive data identifying at least one subscriber and a property at which the subscriber desires service from the service provider. Further, the logic further is configured to initiate service at the property based upon the data via the communication device.

A method for initiating service in accordance with an embodiment of the present disclosure comprises receiving data identifying at least one subscriber and a property associated with the subscriber at which the subscriber desires service and initiating service at the property based upon the data via the communication device.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the figures.

FIG. 1 is a block diagram illustrating an exemplary service initiation system in accordance with an embodiment of the present disclosure.

FIG. 2 is a block diagram illustrating an exemplary subscriber sign-up computing device of the service initiation system as depicted in FIG. 1.

FIG. 3 is a block diagram illustrating an exemplary public computing device such as is depicted in FIG. 2.

FIG. 4 is a block diagram illustrating an exemplary private computing device such as is depicted in FIG. 2.

FIG. 5 is an exemplary “Home” graphical user interface (GUI) displayed to an output device by subscriber sign-up logic of the private computing device such as is depicted in FIG. 4.

FIG. 6 is an exemplary “Partners” GUI displayed to the output device by subscriber sign-up logic of the private computing device such as is depicted in FIG. 4.

FIG. 7 is an exemplary “Services” GUI displayed to the output device by subscriber sign-up logic of the private computing device such as is depicted in FIG. 4.

FIG. 8 is an exemplary “Company: Overview” GUI displayed to the output device by subscriber sign-up logic of the private computing device such as is depicted in FIG. 4.

FIG. 9 is an exemplary “Contact Us” GUI displayed to the output device by subscriber sign-up logic of the private computing device such as is depicted in FIG. 4.

FIG. 10 is an exemplary “Your Connection” GUI displayed to the output device by subscriber sign-up logic of the private computing device when a user logs into the system such as is depicted in FIG. 4.

FIG. 11 is an exemplary “Sign Up—Property Selection” GUI displayed to the output device by subscriber sign-up logic of the private computing device such as is depicted in FIG. 4 when the user selects a “Sign Up New Subscriber” push button on the GUI depicted in FIG. 11.

FIG. 12 is an exemplary “Sign Up—Step 1 (Subscriber Information/Service Types” GUI displayed to the output device by subscriber sign-up logic of the private computing device such as is depicted in FIG. 4 when the user selects the “Next” push button of the “Sign Up—Property Selection” GUI depicted in FIG. 11.

FIG. 13 is a portion of the “Sign Up Step 1 (Subscriber Information/Service Types” GUI depicted in FIG. 12 further showing a pull-down menu of a plurality of dwelling identifiers in accordance with an embodiment of the present disclosure.

FIG. 14 is a portion of the “Sign Up—Step 1 (Subscriber Information/Service Types” GUI depicted in FIG. 12 further showing selected check boxes in accordance with an embodiment of the present disclosure.

FIG. 15 is an exemplary “Provider Requirements/Service Selections” GUI displayed to the output device by subscriber sign-up logic of the private computing device such as is depicted in FIG. 4 when the user checks the “Utility Services” check box of the “Sign Up—Property Selection” GUI depicted in FIG. 11.

FIG. 16 is the “Provider Requirements/Service Selections” GUI depicted in FIG. 15 showing a selected “Standard Services” check box and a list corresponding to the selected “Standard Services” check box.

FIG. 17 is an exemplary “Provider Requirements/Service Selections” GUI displayed to the output device by subscriber sign-up logic of the private computing device such as is depicted in FIG. 4 when the user checks the “Telephone Services” check box of the “Sign Up—Property Selection” GUI depicted in FIG. 11.

FIG. 18 is an exemplary “Provider Requirements/Service Selections” GUI displayed to the output device by subscriber sign-up logic of the private computing device such as is depicted in FIG. 4 when the user checks the “Satellite Services” check box of the “Sign Up Property Selection” GUI depicted in FIG. 11.

FIG. 19 is an exemplary “Order Review/Payment Information” GUI displayed to the output device by subscriber sign-up logic of the private computing device such as is depicted in FIG. 4 when the user selects a “Continue” push button on the GUI depicted in FIG. 18.

FIG. 20 is an exemplary order verification GUI displayed to the output device by subscriber sign-up logic of the private computing device such as is depicted in FIG. 4 when the user selects a “Complete Order” push button on the GUI depicted in FIG. 19.

FIG. 21 is an exemplary “Profile Editor” GUI displayed to the output device by subscriber sign-up logic of the private computing device such as is depicted in FIG. 4 when the user checks a “Modify Profile” link.

FIG. 22 is an exemplary “Newsletters” GUI displayed to the output device by subscriber sign-up logic of the private computing device such as is depicted in FIG. 4 under the “Settings” tab when the user checks a “Newsletters” link.

FIG. 23 is the “Newsletters” GUI depicted in FIG. 20 further illustrating the “Settings” tab having a group selection box list identifying who can send a newsletter.

FIG. 24 is the “Newsletters” GUI depicted in FIG. 20 when a “Compose” tab is selected.

FIG. 25 is the “Newsletters” GUI depicted in FIG. 20 further illustrating the “Compose” tab having a group selection box list to which to send a newsletter.

FIG. 26 is the “Newsletter” GUI depicted in FIG. 20 when the user selects a “Next” push button depicted in FIG. 23.

FIG. 27 is an exemplary “System Error Log” GUI displayed to the output device by subscriber sign-up logic of the private computing device such as is depicted in FIG. 4 when the user checks an “Error Log” link.

FIG. 28 is an exemplary “Activity Log” GUI displayed to the output device by subscriber sign-up logic of the private computing device such as is depicted in FIG. 4 when the user checks an “Error Log” link.

FIG. 29 is an exemplary “Accounts” GUI displayed to the output device by subscriber sign-up logic of the private computing device such as is depicted in FIG. 4 under the “Accounts List” tab and when the user selects an “Accounts” link.

FIG. 30 is the “Accounts” GUI such as is depicted in FIG. 27 under the “Activations (0)” tab.

FIG. 31 is the “Accounts” GUI such as is depicted in FIG. 27 under the “New Account” tab.

FIG. 32 is an exemplary “Groups” GUI displayed to the output device by subscriber sign-up logic of the private computing device such as is depicted in FIG. 4 under a “Groups List” tab.

FIG. 33 is the “Groups” GUI of FIG. 32 when an “Add Group” tab is selected.

FIG. 34 is an exemplary “Manage Permissions” GUI displayed to the output device by subscriber sign-up logic of the private computing device such as is depicted in FIG. 4 under a “Permissions” tab.

FIG. 35 is the exemplary “Manage Permissions” GUI such as is depicted in FIG. 34 under a “Settings” tab.

FIG. 36 is the exemplary “Manage Permissions” GUI such as is depicted in FIG. 34 under a “Settings” tab showing a groups listing.

FIG. 37 is an exemplary “Core Configuration” GUI displayed to the output device by subscriber sign-up logic of the private computing device such as is depicted in FIG. 4 under a “Server Settings” tab.

FIG. 38 is the exemplary “Manage Permissions” GUI such as is depicted in FIG. 37 under a “Base Settings” tab.

FIG. 39 is an exemplary “Manage Permissions” GUI such as is depicted in FIG. 37 under a “Global Settings” tab.

FIG. 40 is an exemplary “Commissions Report” GUI in accordance with an embodiment of the present disclosure generated and displayed by system 100 depicted in FIG. 1.

FIG. 41 is an exemplary “Bounty Report” GUI in accordance with an embodiment of the present disclosure generated and displayed by system 100 depicted in FIG. 1.

FIG. 42 is a flowchart depicting exemplary functionality and architecture of the subscriber sign-up logic of FIG. 4.

### DETAILED DESCRIPTION OF THE INVENTION

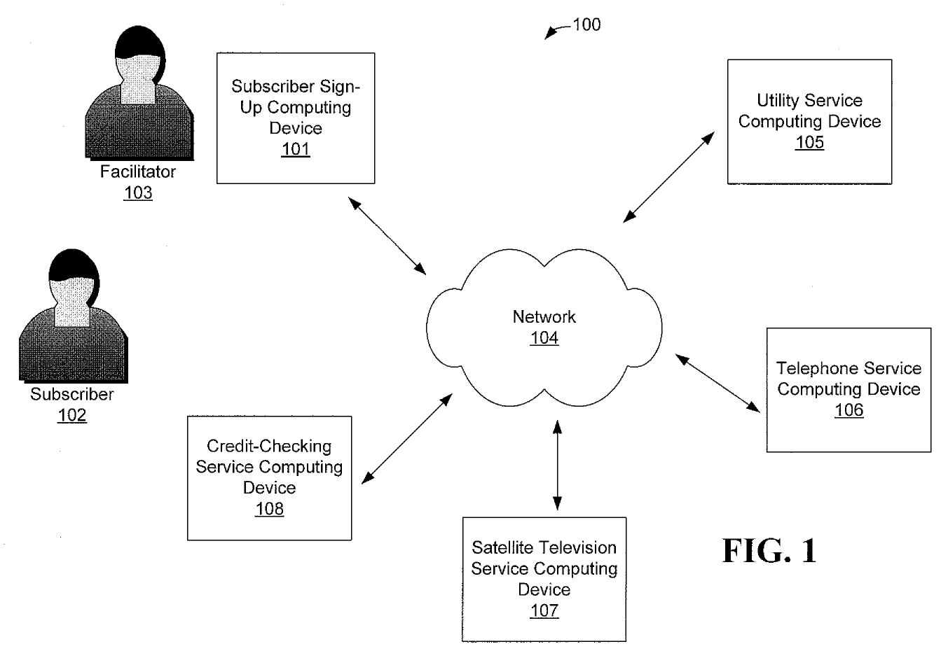

FIG. 1 depicts a service initiation system 100 in accordance with an embodiment of the present disclosure. The system 100 comprises a subscriber sign-up computing device 101 that communicates via a network 104 to a utility service computing device 105, a telephone service computing device 106, and a satellite television service computing device 107. In addition, the system 100 comprises a credit checking computing device 108.

During operation, a facilitator 103 communicates with a subscriber 102 to determine the types of services that the subscriber desires. The facilitator 103 then enters data into the subscriber sign-up computing device 101 indicative of identifying data, e.g., name, address, birth date, driver's license number, and the like. In addition, the facilitator 103 enters data indicative of the types of services the subscriber 102 desires.

The subscriber sign-up computing device 101 transmits data to the service computing device 105-107 related to the types of services desired by the subscriber 102. The data transmitted to the service computing devices 105-107 registers the subscriber 102 for the respective service.

For example, the subscriber 102 may indicate his/her desire to obtain utility services at a particular address. The facilitator 103 enters data into the subscriber sign-up computing device 101 that is needed to sign up the subscriber 102 for utility services. The subscriber sign-up computing device 101 then transmits the data to the utility service computing device 105 that the utility company needs to turn the particular service, i.e., utilities, on at the user's residence or business.

Note that the service computing devices 105-107 are exemplary types of computing devices related to exemplary services that may be desired by the subscriber 102. However, other types of computing devices for registering the subscriber for other types of services are possible in other embodiments of the system 100.

In one embodiment, when the facilitator 103 enters data into the subscriber sign-up computing device 101, the data may indicate that the user 102 desires a service for which a credit check is needed by the service provider, e.g., the utility company, the telephone company, or the satellite company. In such an embodiment, the subscriber sign-up computing device 101 stores data indicative of one or more service providers available to the particular subscriber 102.

Further, the subscriber sign-up computing device 101 stores an acceptable beacon score corresponding to each available service provider. As an example, one or more telephone service providers may be available in a geographic region in which the subscriber 102 desires telephone service. In the example, the subscriber sign-up computing device 101 stores an identifier of each service provider and its associated “acceptable” beacon scores.

An “acceptable beacon score” is a threshold value above which the service provider will allow the subscriber to obtain its service. Notably, the “beacon score” is a value that indicates the subscriber's creditworthiness.

Thus, prior to providing a list of available service providers to the subscriber 102, the subscriber sign-up computing device 101 transmits data to the credit-checking service computing device 108 to request the user's beacon score. The credit-checking service computing device 108, in response, transmits the user's beacon score to the subscriber sign-up computing device 101. Upon receipt, the subscriber sign-up computing device 101 compares the beacon score obtained for the subscriber 102 and one or more threshold values of available service providers. If the subscriber's obtained beacon score exceeds a service provider's acceptable beacon score, the subscriber sign-up computing device 101 makes the service provider for whom it has exceeded available to the subscriber 102.

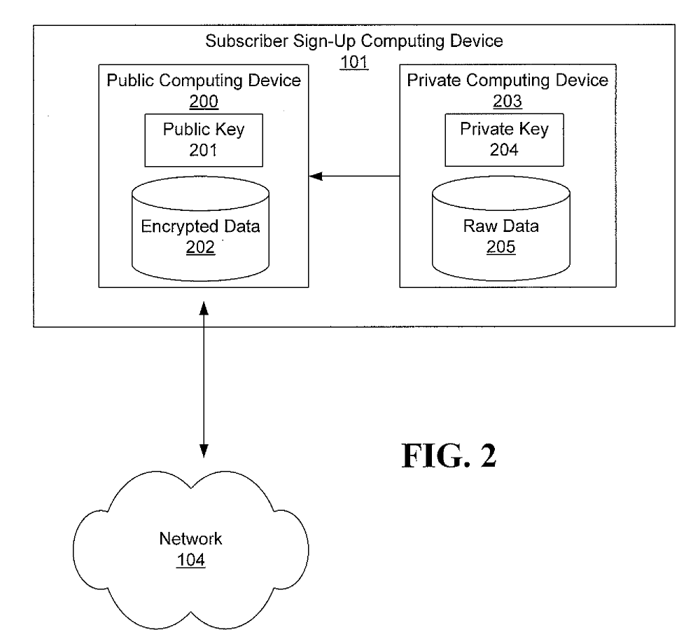

FIG. 2 depicts an exemplary subscriber sign-up device 101 in accordance with one embodiment of the present disclosure. In such an embodiment, the subscriber sign-up device 101 comprises a public computing device 200 and a private computing device 203.

The private computing device 203 receives data indicative of a user's selected services. The private computing device 203 stores the received data as raw data 205 resident on the private computing device 203.

During operation, the private computing device encrypts the raw data 205 using a public key/private key encryption scheme. The private computing device 203 stores a private key 204 locally, and the private computing device 203 stores encrypted data 202 and a public key 201. The public key 201 is associated with the private key 204.

The private computing device 203 limits its communication scheme such that information does not flow readily from the public computing device 200 to the private computing device 203. In this regard, the private key 204 and the raw data 205 are not accessible by a “hacker” from the network 104 through the public computing device 200.

During operation, the public computing device 200 transmits encrypted data 202 and its associated public key 201 to one or more service computing device 105-107 (FIG. 1) desired by the user 102. The private computing device 203 then transmits the private key 204 associated with the already transmitted public key 201 to the service computing device(s) 105-107 that received the encrypted data 202. The service computing device(s) 105-107 use the private key 204 received to decrypt the associated encrypted data 202 to the raw data 205.

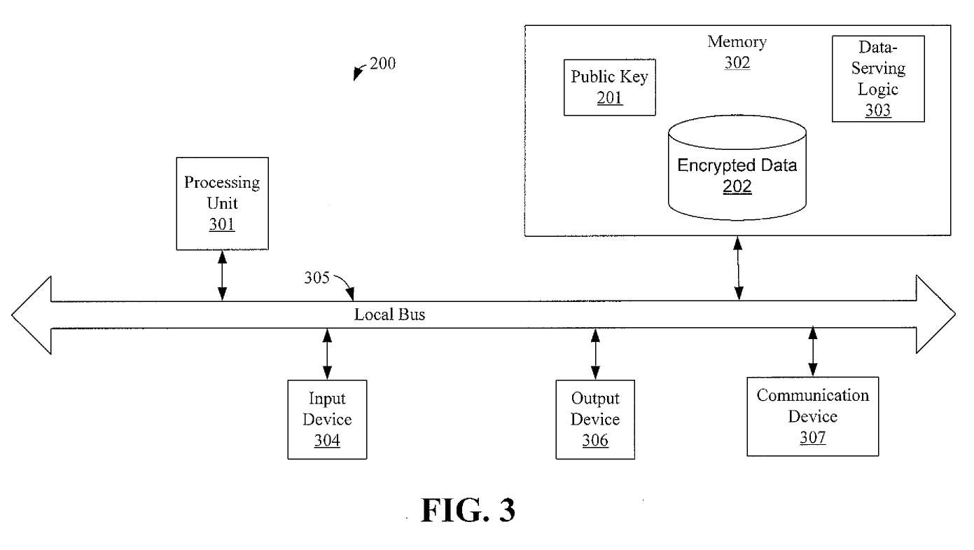

FIG. 3 depicts an exemplary public computing device 200, such as depicted in FIG. 2, in accordance with an embodiment of the present disclosure. The exemplary public computing device 200 generally comprises a processing unit 301, an output device 306, an input device 304, and memory 302. In addition, the public computing device 200 comprises a communication device 307 for communicating over network 104 (FIG. 1).

The public computing device 200 further comprises data-serving logic 303. The data-serving logic 303 can be software, hardware, or a combination thereof. In the exemplary public computing device 200, the data-serving logic 303 is shown as software stored in memory 302.

The processing unit 301 may be a digital processor or other type of circuitry configured to run the data-serving logic 303 by processing and executing the instructions of the data-serving logic 303. The processing unit 301 communicates to and drives the other elements within the public computing device 200 via a local interface 305, which can include one or more buses.

Furthermore, the input device 304, for example, a keyboard, a switch, a mouse, and/or other type of interface, can be used to input data from a user (not shown) of the public computing device 200. Further, the output device 306 can be used to output data to the user, such as, for example, a monitor

When stored in memory 302, the data-serving logic 303 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

During operation, the data-serving logic 303 receives from the private computing device 203 encrypted data 202, which the data-servicing logic 303 stores locally in memory 302. In addition, the data-servicing logic 303 receives one or more public keys 201 associated with the encrypted data 202.

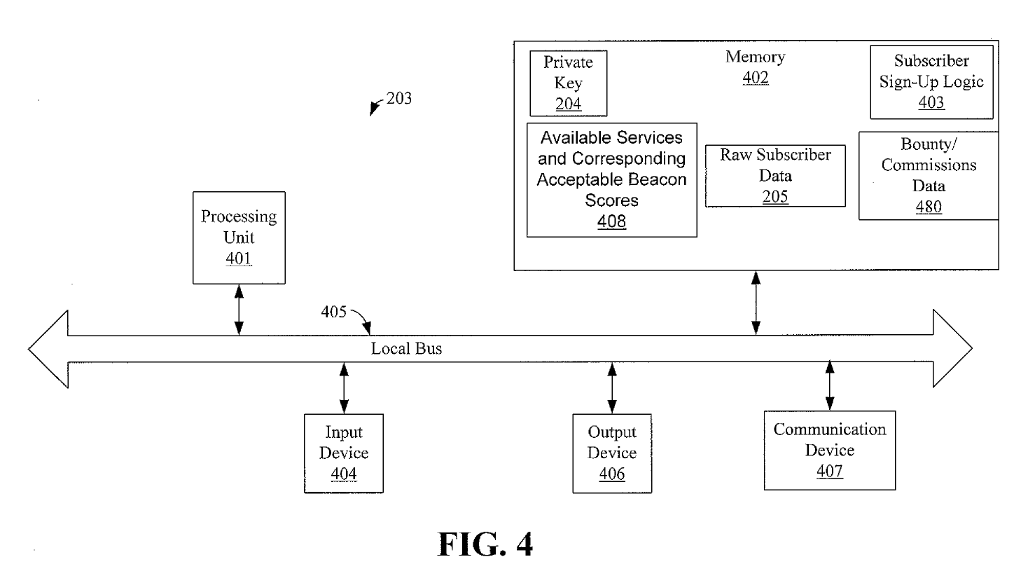

FIG. 4 depicts an exemplary private computing device 203, such as depicted in FIG. 2, in accordance with an embodiment of the present disclosure. The private exemplary computing device 203 generally comprises a processing unit 401, an output device 406, an input device 404, and memory 402. In addition, the private computing device 203 comprises a communication device 407 for communicating over network 104 (FIG. 1).

The private computing device 203 further comprises subscriber sign-up logic 403. The subscriber sign-up logic 403 can be software, hardware, or a combination thereof. In the exemplary private computing device 203, the subscriber sign-up logic 403 is shown as software stored in memory 402.

The processing unit 401 may be a digital processor or other type of circuitry configured to run the subscriber sign-up logic 403 by processing and executing the instructions of the subscriber sign-up logic 403. The processing unit 401 communicates to and drives the other elements within the private computing device 203 via a local interface 405, which can include one or more buses.

Furthermore, the input device 404, for example, a keyboard, a switch, a mouse, and/or other type of interface, can be used to input data from a user (not shown) of the private computing device 200. Further, the output device 406 can be used to output data to the user, such as, for example, a monitor

When stored in memory 402, the subscriber sign-up logic 403 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

During operation, the subscriber sign-up logic 403 receives data from the input device 404 entered by the facilitator 103 (FIG. 1) related to the services desired by the subscriber 102. As described hereinabove, the facilitator 103 may be, for example, a leasing agent for an apartment complex, and the subscriber 102 is renting a dwelling from the leasing agent. In another embodiment, facilitator 103 may be a real estate agent or broker who has recently sold a house. In such an embodiment, the real estate agent or broker signs its buyer up for desired services.

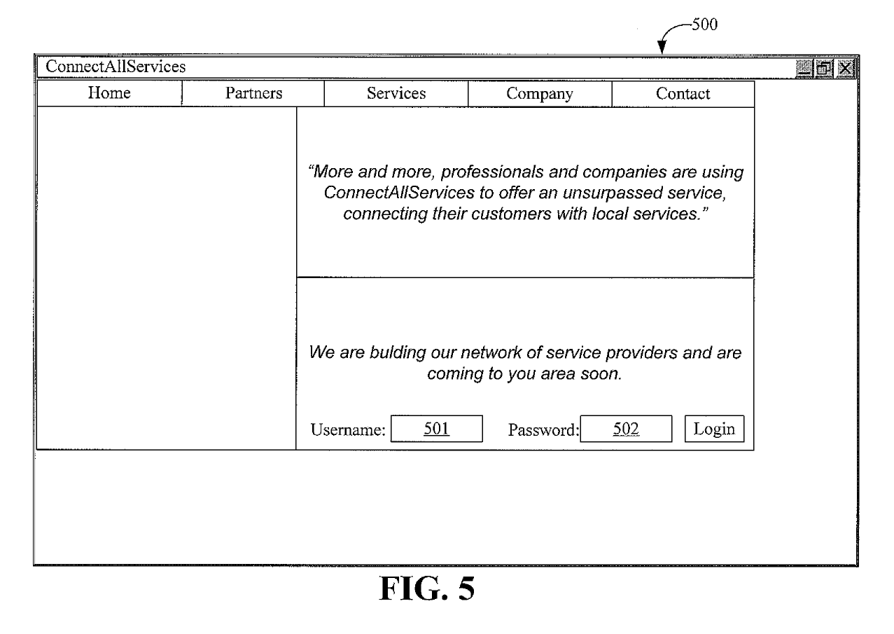

In one embodiment, the raw data 205 is captured from the facilitator 103 through a series of graphical user interfaces, and such an embodiment is described further with reference to FIGS. 5-41.

Once the subscriber sign-up logic 403 stores the raw data 205 entered by the facilitator 103, the subscriber sign-up logic 403 encrypts the raw data 205 using a public key/private key encryption scheme. Thus, the subscriber sign-up logic 403 generates the public key 201 (FIG. 3) and the private key 204, encrypts the raw data 205 with the keys 201 and 204, and stores the encrypted data 202 and the public key 201 on the public computing device 200 (FIG. 3).

Once raw data 205 requesting an order for a particular service is submitted and/or completed, the subscriber sign-up logic 403 transmits a message to the data-server logic 303 to transmit the encrypted data 205 and related public key 201 to the services computing device 105-107 related to the data 205. As an example, if the subscriber 102 desired utility service, then the subscriber sign-up logic 403 requests that the data-serving logic 303 transmit the encrypted data 205 related to the service request to the utility service computing device 105.

In addition, the subscriber sign-up logic 403 transmits a private key 204 associated with the encrypted data 205 to the service computing device 105-107 (FIG. 1). The subscriber sign-up logic 403 transmits the private key 204 directly to the computing device 105-107 via the communication device 407. Upon receipt, the service computing device 105-107 decrypts the encrypted data 205 received from the public computing device 200 by the data-servicing logic 303 using the public key 201 received from the data-serving logic 303 and the private key 205 received from the subscriber sign-up logic 403.

Memory 402 further stores bounty/commission data 480. The bounty/commission data 480 is data indicative of the amount of money paid by a particular service provider as a “bounty” when a facilitator 103 signs up a new customer. The term “bounty” refers to money paid by the service provider to the facilitator 103, an employer of the facilitator 103, or the like, when a sign-up is completed. This bounty may be paid to the employer of the facilitator 103, and in turn the employer may pay a “commission” to the facilitator 103.

Furthermore, the private computing device 203 stores data 408 indicative of available services and corresponding acceptable beacon score. As described hereinabove, the system 110 would serve a particular geographic region. Therefore, those companies available in the region and their acceptable beacon scores are stored as data 408. Data 408 may be manually entered via input device 404 or automatically retrieved from computing devices 105-107 via communication device 407.

FIG. 5 depicts a “Home” GUI 500 in accordance with an exemplary embodiment of the present disclosure. This GUI 500 is an initial screen viewed by the facilitator 103 (FIG. 1) when using the system 100 (FIG. 1). The facilitator 103 can logon to the system 100 by entering a “Username” in text field 501, a password in text field 502, and selecting the “Log-in” push button 503.

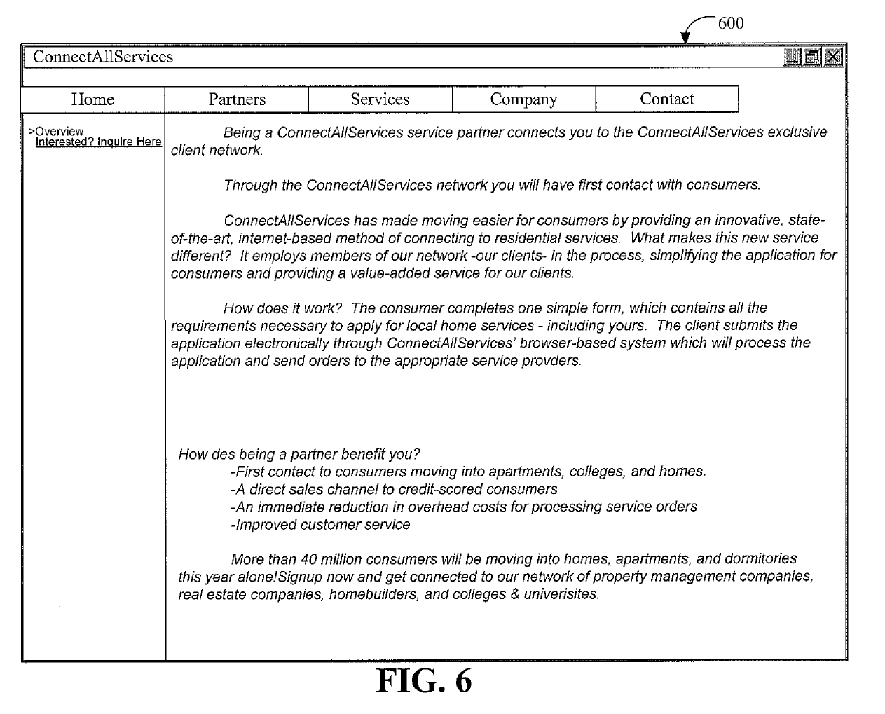

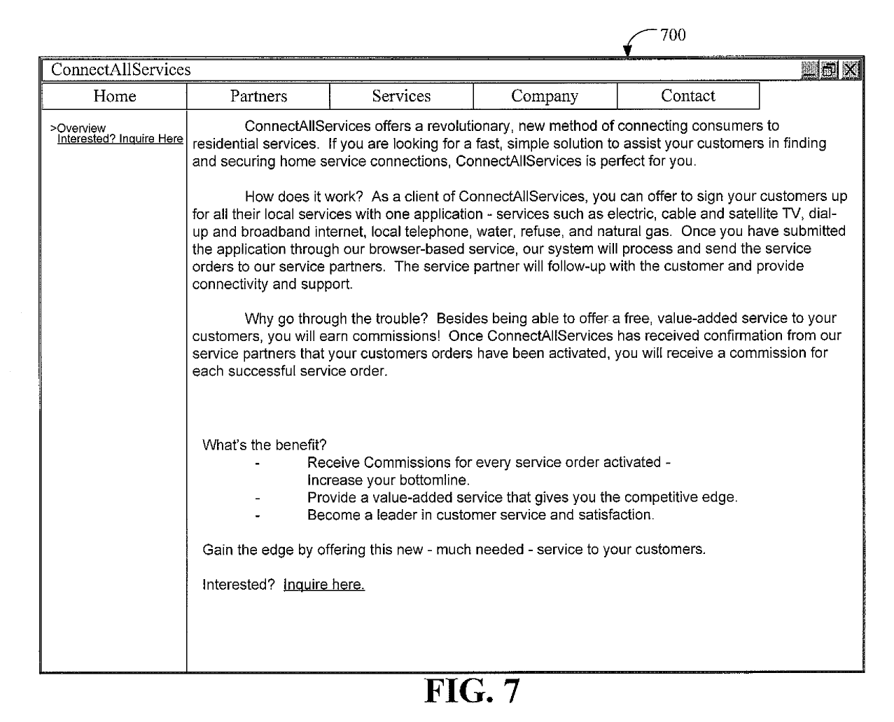

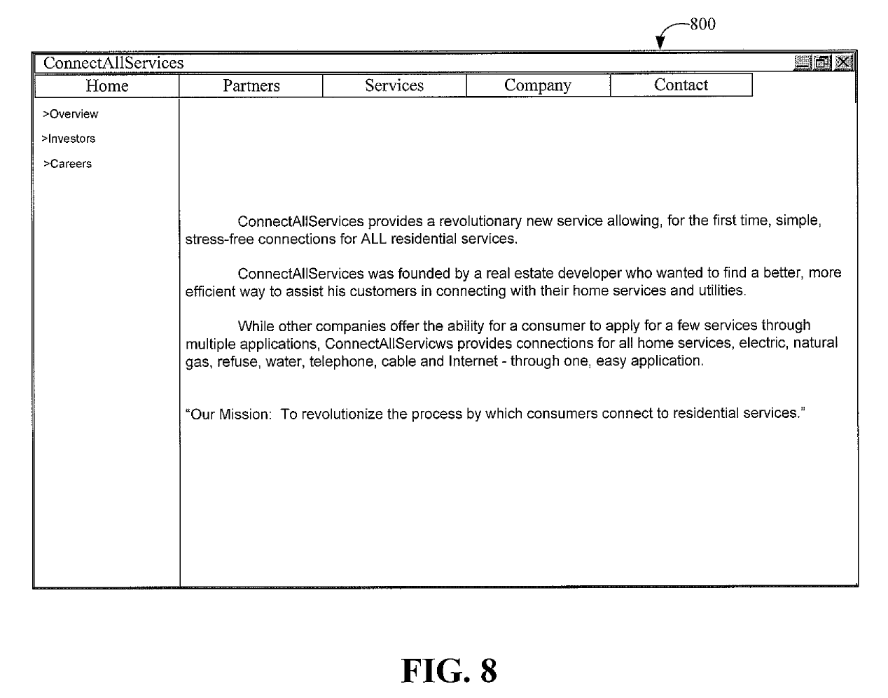

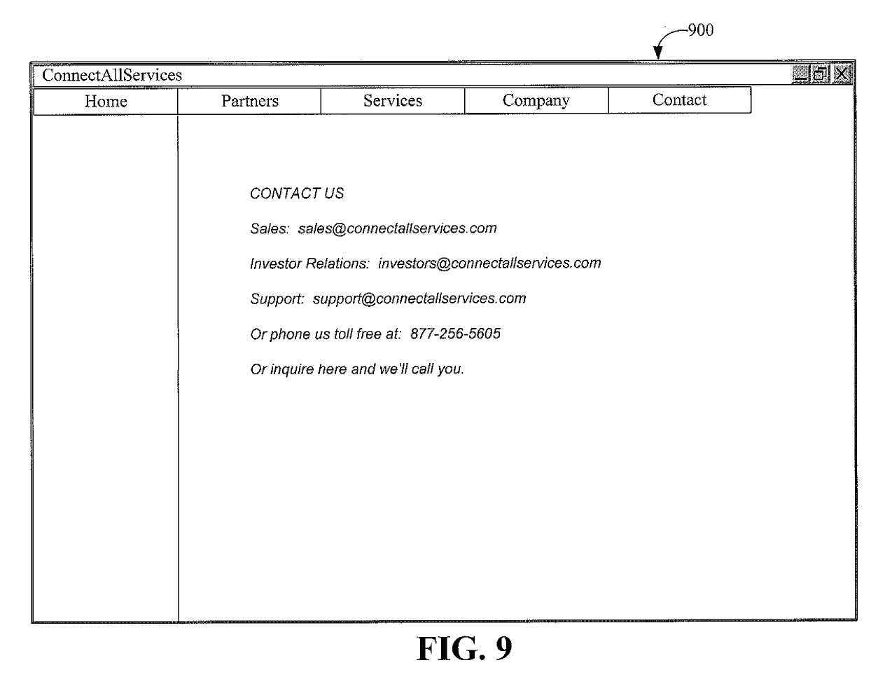

Other general screens are described with reference to FIGS. 6-9. FIG. 6 depicts a “Partners” GUI 600 in accordance with an exemplary embodiment of the present disclosure. Further, FIG. 7 depicts a “Services” GUI 700, FIG. 8 depicts a “Company: Overview” GUI 800, and FIG. 9 depicts a “Contact Us” GUI 900 all in accordance with an exemplary embodiment of the present disclosure.

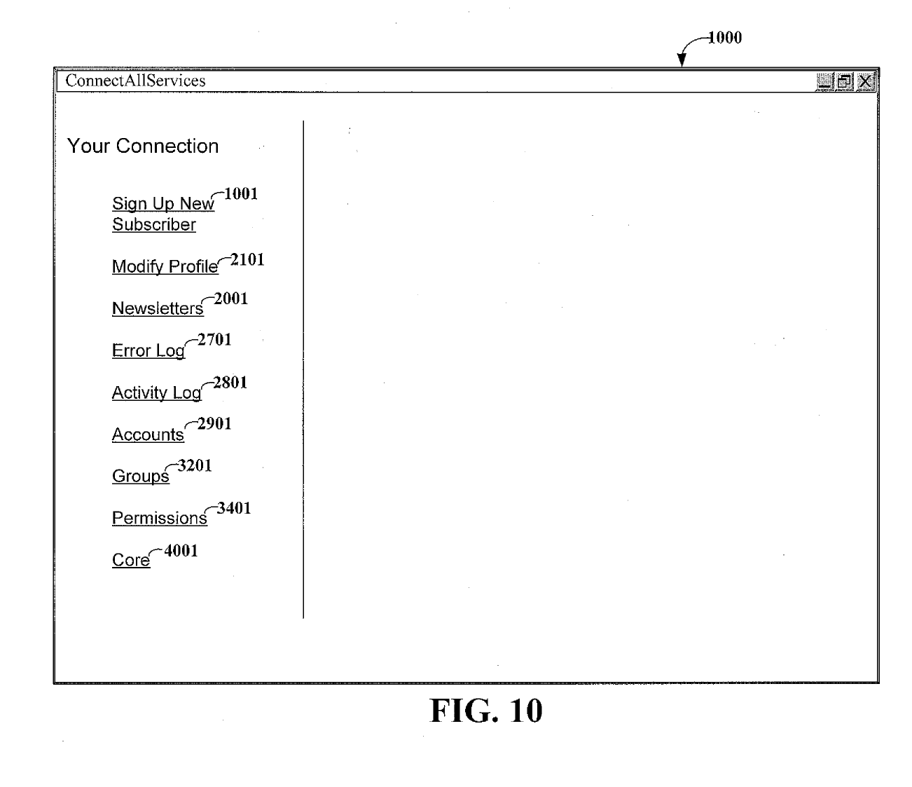

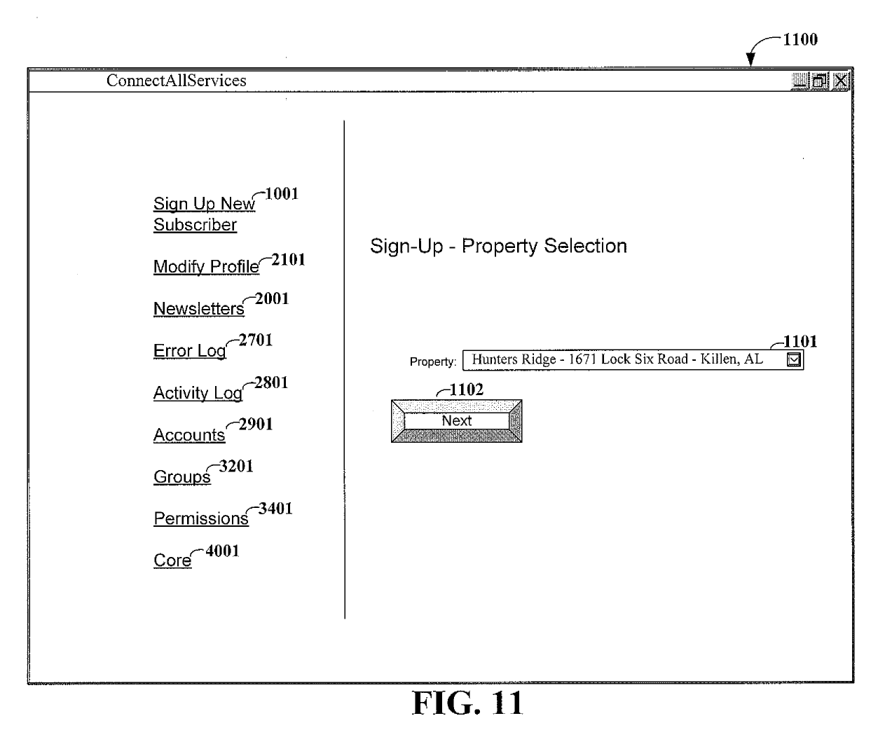

From any GUI 500, 600, 700, 800, or 900, the facilitator 103 can enter the “Username” and “Password” and log on to the system 100. Once the “Log-In” push button 503 (FIG. 5) is selected, the subscriber sign-up logic 403 (FIG. 4) displays the “Your Connection” GUI 1000 depicted in FIG. 10 comprising a plurality of links, including a “Sign-Up New Subscriber” link 1001, a “Modify Profile” link 2101, a “Newsletter” link 2001, an “Error Log” link 2701, an “Activity Log” link 2801, an “Accounts” link 2901, a “Groups” link 3201, a “Permissions” link 3401, and a “Core” link 4001 (Collectively referred to as the “navigation links”). When the user selects one of the navigation links, the subscriber sign-up logic 403 displays one or more GUIs according to the navigation link selected. Each GUI displayed is described further herein with reference to FIGS. 11-41.

Referring to FIG. 11 in particular, when the subscriber sign-up link 1001 is selected, the subscriber sign-up logic 403 displays a “Sign Up—Property Selection” GUI 1100 to the output device 406 (FIG. 4). The subscriber sign-up link 1001 is selected by the facilitator 103 when the facilitator 103 desires to sign a subscriber up for a particular service.

The “Sign Up—Property Selection” GUI 1100 comprises at least a pull down selection field 1101 and a “Next” push button 1102. The facilitator 103 uses the field 1101 to select a property that the subscriber 102 (FIG. 1) is leasing or at which is otherwise residing and at which the subscriber 102 desires a particular service, e.g., utilities, telephone, or satellite. The example indicated is “Hunters Ridge—1671 Lock Six Road—Killen, Ala.”

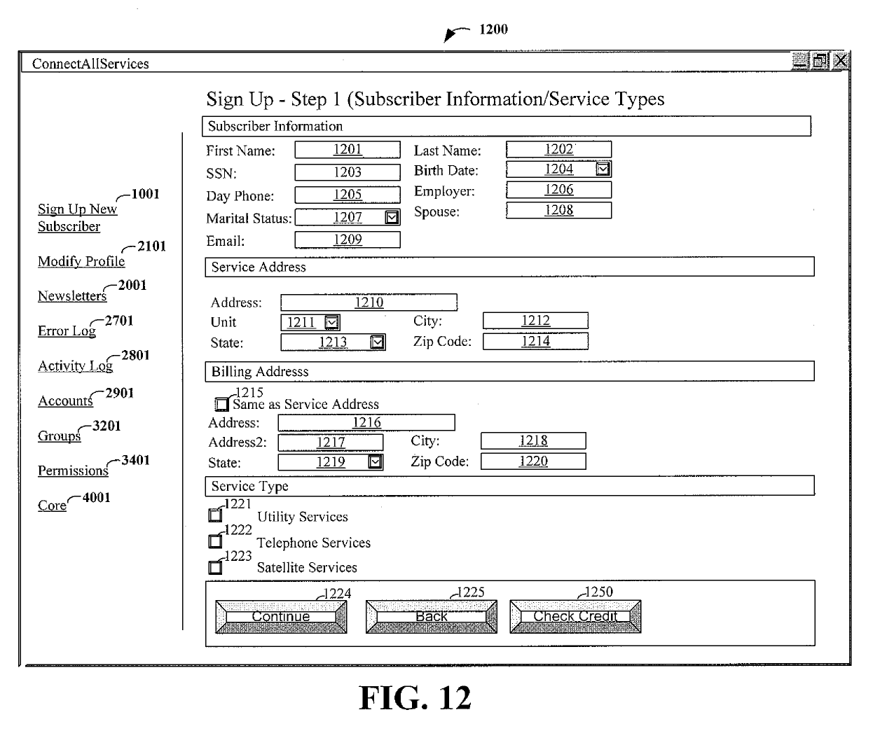

After selection, the facilitator 103 selects the “Next” push button 1102. When push button 1102 is selected, the subscriber sign-up logic 403 displays a “Sign Up—Step 1 (Subscriber Information/Service Types” GUI 1200 such as depicted in FIG. 12.

The GUI 1200 comprises a “Subscriber Information” tier comprising a “First Name” text field 1201, “Last Name” text field 1202, Social Security Number (“SSN”) text field 1203, “Date of Birth” pull down selection list 1204, “Daytime Phone” text field 1205, “Employer” text field 1206, “Marital Status” pull down selection list 1207, “Spouse Name” text field 1208, and “Email” text field 1209. Each of these data entry components is for receiving identifying information related to the subscriber 102 that desires service hook-up to a dwelling.

Since the address of the subscriber 102 and the address at which service is needed may differ, there is a “Service Address” tier. The “Service Address” tier comprises an “Address” text field 1210, “Unit” pull down selection list 1211, “City” text field 1212, “State” pull down selection list 1213, and “Zip Code” text field 1214. Each of these data entry components is for receiving identifying information related to an alternate service address to which service is desired.

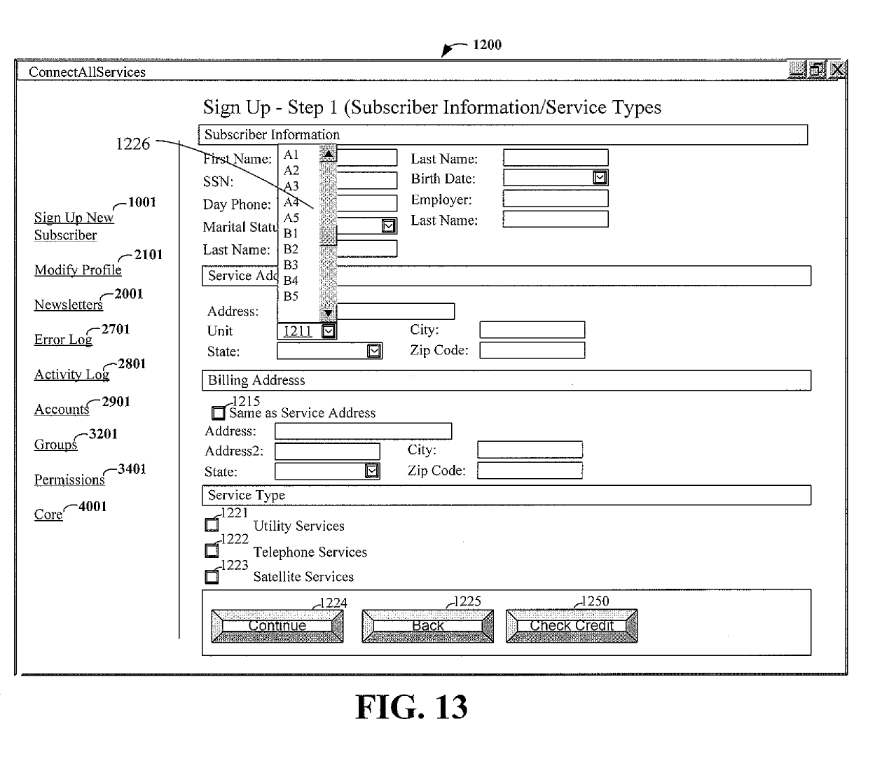

Note that FIG. 13 illustrates in more detail the “Unit” pull down selection list 1211. In this regard, when the facilitator 103 (FIG. 1) selects the “Unit” pull down selection list, the subscriber sign-up logic 403 (FIG. 4) displays a list 1226 comprising a plurality of units A1-A5 and D1-D5 associated with the property selected in GUI 900 (FIG. 9).

Additionally, with respect to FIG. 12, the GUI 1200 comprises a “Billing Address” Tier for when the billing address for the service is different than that entered under “Subscriber Information” and “Service Address.” If the information is the same as the “Service Address” information, the GUI comprises a “Same as Service Address” check box 1215. The GUI 1200 further comprises two “Address” text fields 1216 and 1217, “City” text field 1218, “State” pull down selection list 1219, and “Zip Code” text box 1220. Each of these data entry components is for receiving identifying information related to an alternate billing address.

In addition, the GUI 1200 comprises a “Service Type” tier. The “Service Type” tier is for identifying the types of services desired by the user. In the exemplary GUI 1200, the exemplary services are “Utility Services,” “Telephone Services,” and “Satellite Services.” Each of these services corresponds to a check box 1221-1223, respectively. Thus, if the subscriber 102 desires utility, telephone, or satellite, the facilitator 103 selects check boxes 1221-1223, respectively.

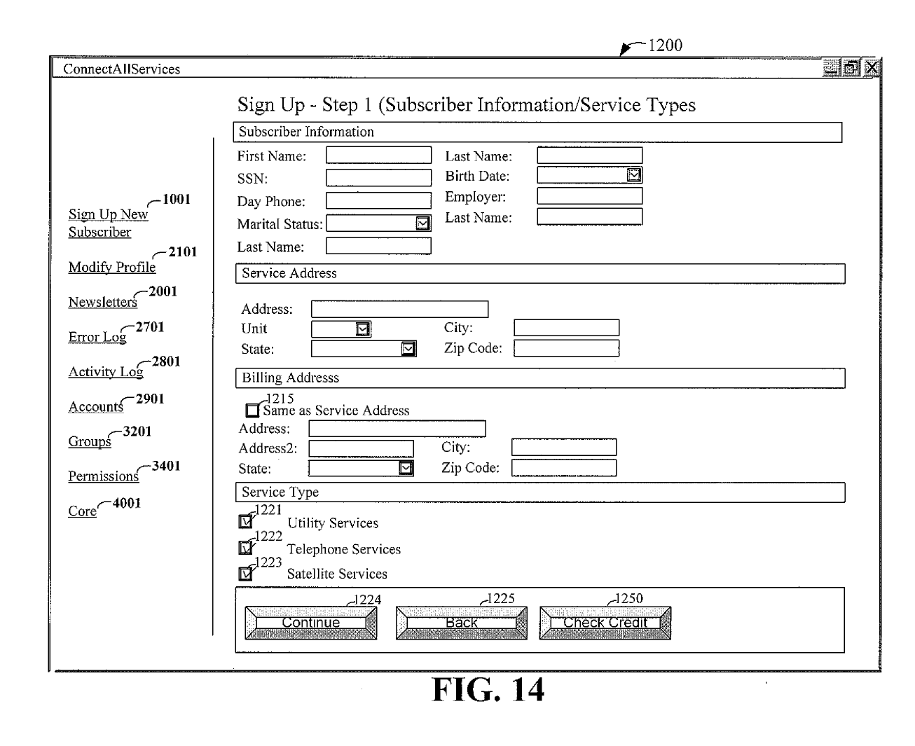

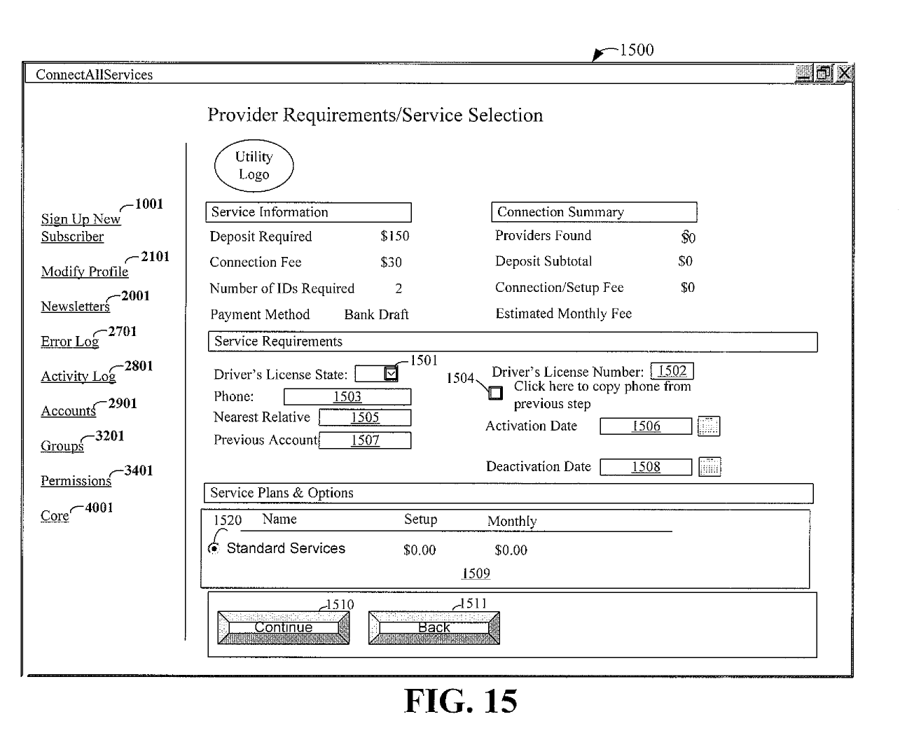

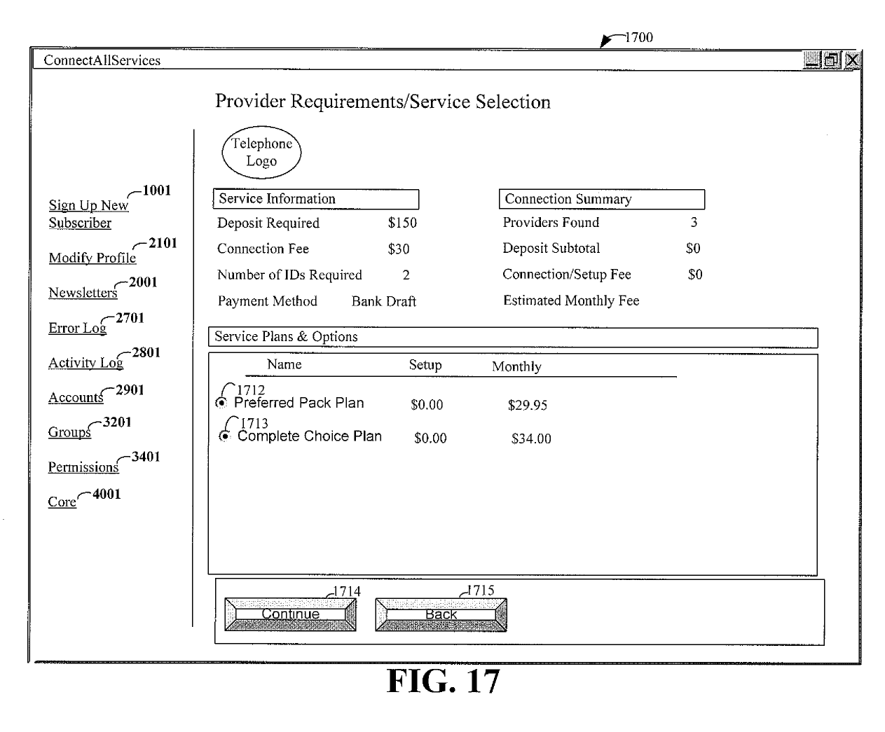

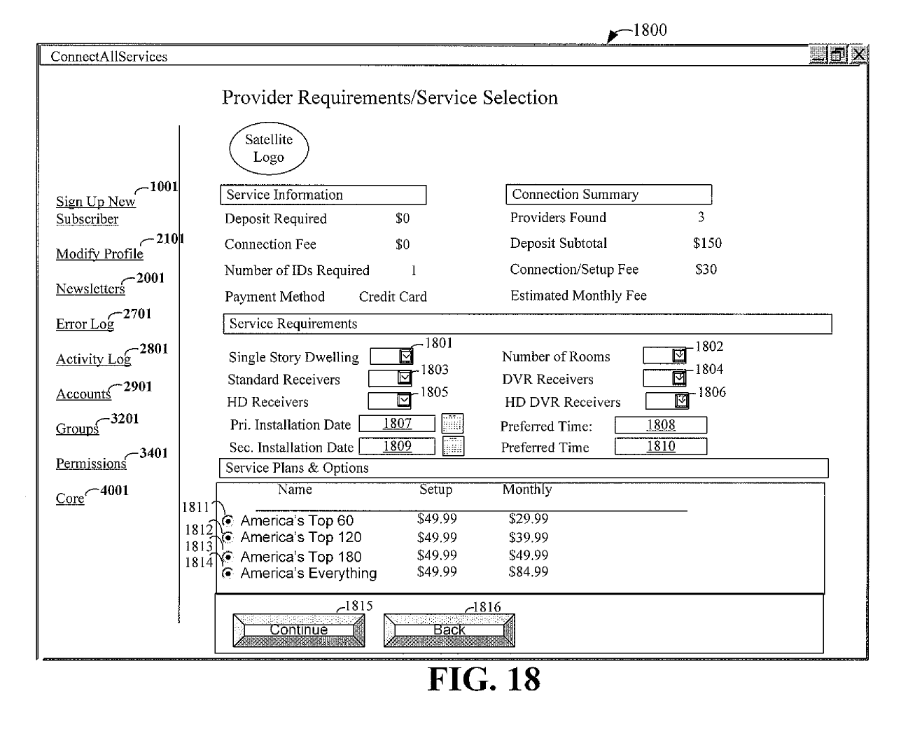

Note that FIG. 14 illustrates in more detail the selection of check boxes 1221-1223. In this regard, when the facilitator 103 (FIG. 1) selects the check boxes 1221-1223 as indicated by the “√” in each of the boxes 1221-1223, the subscriber sign-up logic 403 (FIG. 4) displays consecutively three “Provider Requirements/Service Selections” GUIs 1500 (FIG. 15), 1700 (FIG. 17), and 1800 (FIG. 18) corresponding to each of the checked boxes. Each of these screens is described in more detail herein.

The GUI 1200 further comprises a “Back” push button 1225. Upon selection of the “Back” push button 1225, the subscriber sign-up logic 403 displays the GUI 1100 in FIG. 11. Thus, the facilitator 103 can, throughout the process, return to a previous GUI. This is consistent with respect to each GUI described herein and their associated “Back” push buttons.

Once the facilitator 103 enters information indicative of the subscriber 102 in GUI 1200 as described hereinabove, the subscriber sign-up logic 403 stores the information as the raw data 205 (FIG. 2). When the facilitator 103 selects a “Credit Check” push button 1250, the subscriber sign-up logic 403 transmits the raw data 205 to the credit-checking service computing device 108 (FIG. 1), and the credit-checking service computing device 108 receives the raw data 205 and transmits to the subscriber sign-up computing device 101 a beacon score corresponding to the subscriber 102 described by the raw data 205.

The subscriber sign-up logic 403 compares the received beacon score to one or more of the available services' corresponding acceptable beacon scores 408 (FIG. 4). Therefore, when the facilitator 103 selects a “Continue” push button 1224, the subscriber sign-up logic 403 activates one or more service-related portions, e.g., a utility portion, a telephone portion, or a satellite portion, based upon the services selected in check boxes 1221-1223 and based upon the comparison of the subscriber's beacon score. In this regard, the subscriber sign-up logic 403 displays in consecutive order only those service providers for which the boxes 1221-1223 are selected and the subscriber's beacon score exceeded the acceptable beacon score of the respective available service providers.

As an example, subscriber 102 may desire telephone service in a particular geographic region. There may be two available telephone service providers in the region. In such an embodiment, the facilitator 103 selects the “Telephone Services” check box 1222. Note that the subscriber sign-up logic 403 may comprise one or more flags (not shown) associated with the one or more available telephone service providers. Accordingly, in such an example, the subscriber sign-up logic 403 may “set” the flag of each available service provider, e.g., associate with the two available service providers a Furthermore, the subscriber sign-up logic 403 obtains the subscriber's beacon score from the credit-checking service computing device 108. The subscriber sign-up logic 403 compares the subscriber's beacon score with the acceptable beacon score of each available telephone service provider. If the subscriber's beacon score only exceeds one of service provider's acceptable beacons scores, the subscriber sign-up logic 403 only sets the flag of the service provider for which the subscriber's beacon score exceeded.

Note that based upon the flags set as described hereinabove, the subscriber sign-up logic 403 consecutively displays one or more GUIs, e.g., 1500 (FIG. 15), 1700 (FIG. 17), or 1800 (FIG. 18), corresponding to the selected check boxes 1221-1223 and the comparison of the subscriber's beacon score. As another example, if all three check boxes 1221-1223 are selected and the subscriber's beacon score exceeds the acceptable beacon score of available service providers, the subscriber sign-up logic 403 displays the GUI 1500 first, receiving data from the facilitator 103 related to the GUI 1500. Once the facilitator 103 is ready to move to another GUI, he/she selects a “Continue” push button 1224 to proceed, and the Subscriber sign-up logic 403 displays the next GUI related to the check boxes 1221-1223 selected, e.g., GUI 1500, and so on.

Accordingly, in the example provided, the subscriber sign-up logic 403 (FIG. 4) displays a “Provider Requirements/Service Selections” GUI 1500, if the check box 1221 (FIG. 12) is selected, for utility services. Note that under a “Service Information” the GUI 1500 describes a “Deposit Required” of $150.00, a “Connection Fee” of $30.00, a “Number of [Identifications] IDs Required” of 2, and a “Payment Method” of Bank Draft. Further note that under a “Connection Summary, the GUI 1500 may describe additional information, for example, “Providers Found of 2”, a “Deposits Subtotal,” a “Connection/Setup Fees Subtotal,” or an “Estimated Monthly Fee.”

In displaying the “Service Information” and the “Connection Summary,” the subscriber sign-up logic 403 may query a remote database (not shown) to obtain the information. As an example, the subscriber sign-up logic 403 may query a remote database to determine how many providers are available for the property selected or the subscriber sign-up logic 403 may have this data resident in a local database. In addition, the subscriber sign-up logic 403 may query a database on, for example, the utility service computing device 105 (FIG. 1), the telephone service computing device 106 (FIG. 1), or the satellite television service computing device 107 (FIG. 1) related to the service and display the data indicative of the “Service Information” or “Connection Summary.”

The GUI 1500 further comprises a “Service Requirements” tier and a plurality of associated data entry components for entering data required to set up service for the identified utility. Such data entry components comprise a “Driver's License State” pull down selection menu 1501, a Driver's License #” text field 1502, a “Phone” text field 1503, a check box 1504 to click to copy contact number from GUI 1200 (FIG. 12), a “Nearest Relative” text field 1505, an “Activation Date” text field 1506 with a corresponding calendar for date retrieval, a “Previous Account #” text field 1507, and a “Deactivation Date” text field 1508 with a corresponding calendar for date retrieval. The required fields for the particular identified service provider may be obtained real-time from a remote database, including a database stored on the utility service computing device 105 (FIG. 1).

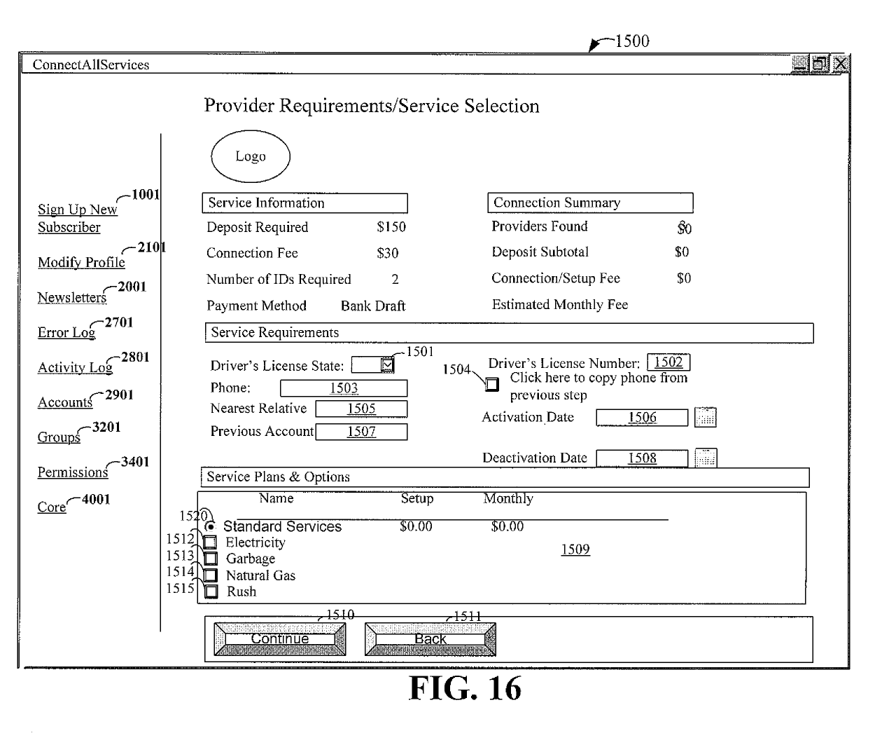

Additionally, GUI 1500 comprises a box 1509 that lists the “Service Plans & Options”. Box 1509 comprises a list of the different plans available to the subscriber 102 (FIG. 1) related to the property selected. As an example, box 1509 comprises a selection button 1520 showing a “Standard Services” option and corresponding “Setup” and “Monthly” fees. If the “Standard Services” button 1520 is selected, the subscriber sign-up logic 403 displays a list of other options available to the subscriber 102 as shown with reference to FIG. 16. In this regard, the list in FIG. 16 shows the options of “Electricity” check box 1512, “Garbage” check box 1513, “Natural Gas” check box 1514, and “Rush Connection” check box 1515, which can be selected as a service by the subscriber 102.

With reference to FIG. 17, the subscriber sign-up logic 403 (FIG. 4) displays a “Provider Requirements/Service Selections” GUI 1700, if the check box 1222 (FIG. 12) is selected, for telephone services. Note that under a “Service Information” the GUI 1700 describes a “Deposit Required,” a “Connection Fee,” a “Number of [Identifications] IDs Required,” and a “Payment Method,” similar to GUI 1550 of FIG. 15. Further note that under a “Connection Summary, the GUI 1700 describes additional information, for example, “Providers Found” of 3, a “Deposits Subtotal” of $150.00, a “Connection/Setup Fees Subtotal” of 30.00, or an “Estimated Monthly Fees.”

In displaying the “Service Information” and the “Connection Summary,” the subscriber sign-up logic 403 may query a remote database to obtain the information. As an example, the subscriber sign-up logic 403 may query a remote database to determine how many providers are available for the property selected or the subscriber sign-up logic 403 may have this data resident in a local database. In addition, the subscriber sign-up logic 403 may query a database on, for example, the telephone service computing device 106 (FIG. 1) related to the service and display the data indicative of the “Service Information” or “Connection Summary.”

Additionally, GUI 1700 of FIG. 17 comprises a listing of the different plans available to the subscriber 102 (FIG. 1) related to the property selected. As an example, the facilitator 103 (FIG. 1) may select selection box 1712 for the “Preferred Pack Plan” for a monthly fee of $29.95 or the “Complete Choice Plan” selection box 1713 for a monthly fee of $34.00.

From GUI 1700, the facilitator 103 may select a “Back” push button 1715 that will return to GUI 1500 (FIG. 15) or a “Continue” push button 1714. If the “Continue” push button 1714 is selected, the subscriber sign-up logic 403 displays a “Provider Requirements/Service Selections” GUI 1800 for the next service selected in check boxes 1221-1223 in FIG. 12. In the example provided, the facilitator 103 further selected the check box 1223.

Accordingly, with reference to FIG. 18, the subscriber sign-up logic 403 (FIG. 4) displays a “Provider Requirements/Service Selections” GUI 1800, because the check box 1223 (FIG. 12) is selected, for satellite services. Note that under a “Service Information” the GUI 1800 describes a “Deposit Required,” a “Connection Fee,” a “Number of [Identifications] IDs Required,” and a “Payment Method” as “Credit Card,” as described similarly with reference to FIG. 15. Further note that under “Connection Summary, the GUI 1800 may describe additional information, for example, “Providers Found” of 3, a “Deposits Subtotal” of $150.00, a “Connection/Setup Fees Subtotal” of 30.00, or an “Estimated Monthly Fees.”

In displaying the “Service Information” and the “Connection Summary,” the subscriber sign-up logic 403 may query a remote database to obtain the information. As an example, the subscriber sign-up logic 403 may query a remote database to determine how many providers are available for the property selected or the subscriber sign-up logic 403 may have this data resident in a local database. In addition, the subscriber sign-up logic 403 may query a database on, for example, the satellite service computing device 107 (FIG. 1) related to the satellite service and display the data indicative of the “Service Information” or “Connection Summary.”

The GUI 1800 (FIG. 18) further comprises a “Service Requirements” tier and a plurality of associated data entry components for entering data required to set up service for the identified utility, e.g., “Dish Pronto,” as identified. Such data entry components comprise a “Single Story Dwelling” selection box 1801, “Number of Rooms” pull down menu 1802, “Standard Receivers” pull down menu 1803, “DVR Receivers” pull down menu 1804, “HD Receivers” pull down 1805, “HD DVR Receivers” pull down menu 1806, “Installation Date” text field 1807, “Preferred Time” pull down menu 1808, “Installation Date” text field 1809, and “Preferred Time” pull down menu 1810 for entering data related to the satellite service.

Additionally, GUI 1800 comprises a listing of the different plans available to the subscriber 102 (FIG. 1) related to the property selected. As an example, the facilitator 103 may select selection box 1811 for the “America's Top 60” for a set up fee of $49.99 and monthly fee of $29.99, selection box 1812 for the “America's Top 120” for a set up fee of $49.99 and a monthly fee of $39.99, selection box 1813 for the “America's Top 180” for a set up fee of $49.99 and a monthly fee of $49.99, or selection box 1814 the “America's Everything Pack” for a set up fee of $49.99 and a monthly fee of $84.99.

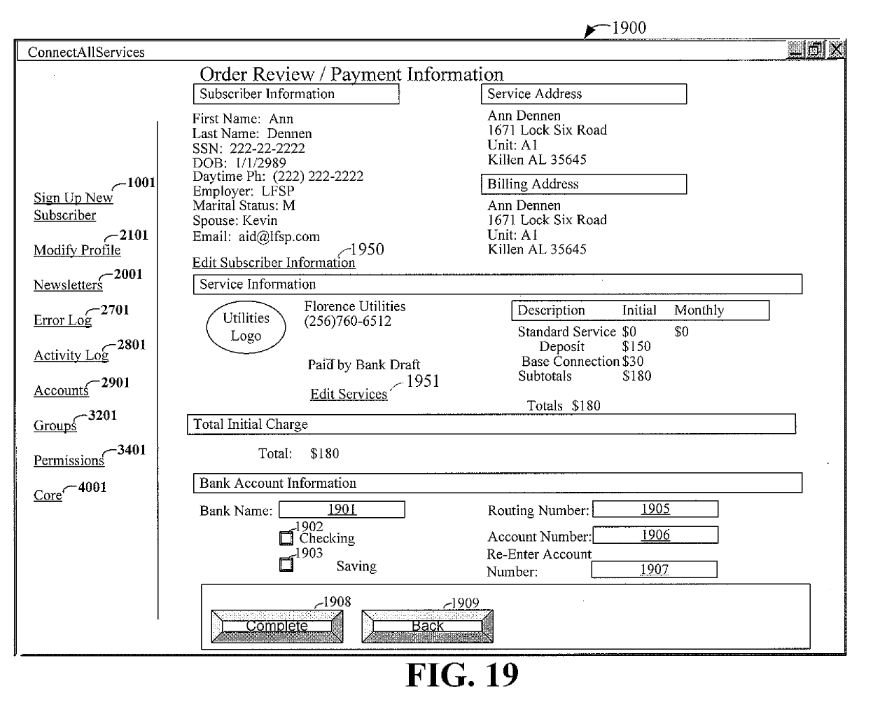

From GUI 1800, the facilitator 103 may select a “Back” push button 1816 that will return to GUI 1700 (FIG. 17) or a “Continue” push button 1815. If the “Continue” push button 1815 is selected, the subscriber sign-up logic 403 displays an “Order Review/Payment Information” GUI 1900 (FIG. 19).

GUI 1900 provides a summary of all the services for which the facilitator 103 (FIG. 1) signed up the subscriber 102 (FIG. 1). The GUI 1900 comprises a “Subscriber Information” tier that reiterates the “Subscriber Information” entered in FIG. 12. The GUI 1900 further comprises a listing of the services obtained for the subscriber under a “Service Information” tier, and a total of the charges under a “Total Initial Charge Information” tier.

Additionally, the GUI 1900 comprises a “Bank Account Information” tier. The facilitator 103 can enter “Bank Name” in text box 1901, select whether the account is a “Checking” or “Savings” account in selection boxes 1902 and 1903, the “Routing Number” from the check in text field 1905, the “Account Number” of the subscriber 102 in text field 1906, and for security, reenter the account number in the “Re-enter Account Number” text field 1907.

As described hereinabove with reference to FIG. 4, the information obtained is stored on a private computing device 203. Prior to sending the data indicative of the bank account information obtained, the subscriber sign-on logic 403 encrypts the data using a public/private key encryption scheme.

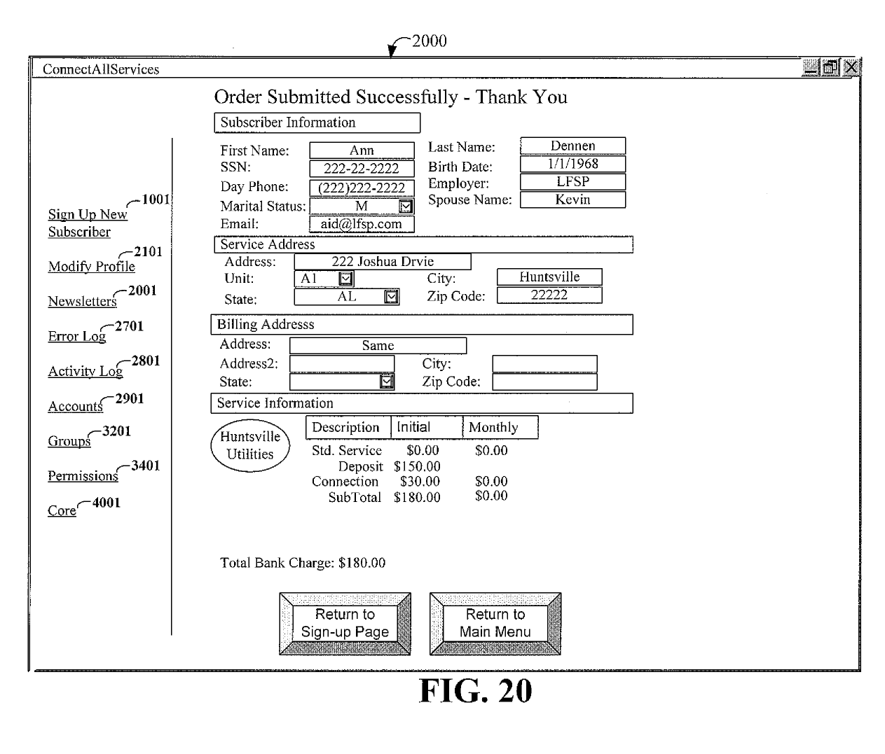

Once the services are ordered, the subscriber sign-on logic 403 displays an “Order Submitted Successfully” GUI 2000 as shown in FIG. 20.

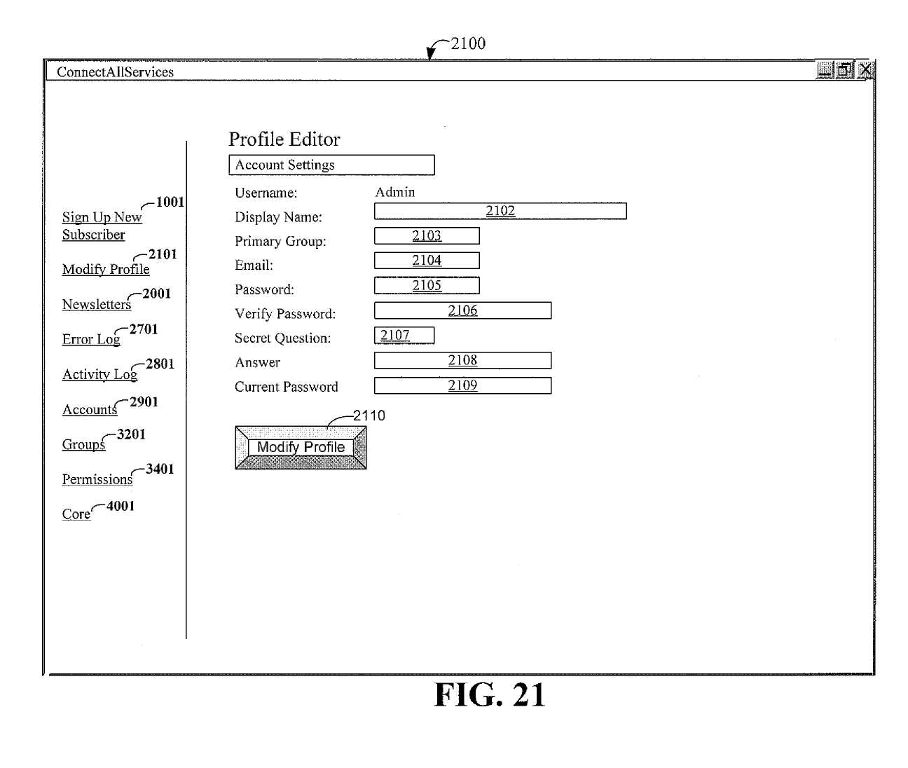

When the facilitator 103 (FIG. 1) selects a “Modify Profile” link 2101 from the navigation links, the subscriber sign-up logic 403 (FIG. 4) displays a “Profile Editor” GUI 2100, as shown in FIG. 21. The GUI 2100 allows the facilitator 103 to update account profiles.

In this regard, the facilitator 103 can enter a “Display Name” in text field 2102 and identify a “Primary Group” to which the account belongs in “Primary Group” pull down menu 2101. Further, the GUI 2100 comprises an “Email” text field 2104, a “Choose Password” text field 2105, a “Verify Password” text field 2106, a “Secret Question” text field 2107, and “Answer” text field 2108 corresponding to the question identified, and a “Current Password” text field 2109.

Upon selection of the “Modify Profile” push button 2110, the subscriber sign-up logic 403 updates the information provided in the data entry components 2101-2108 of GUI 2100.

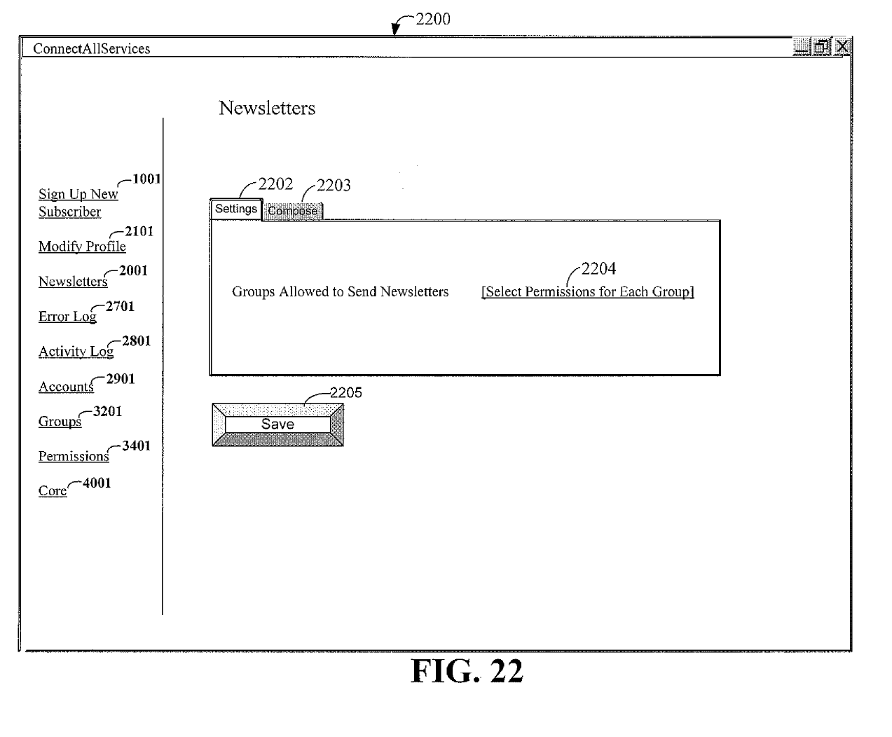

If the facilitator 103 selects the “Newsletters” link 2001 in FIG. 21, the subscriber sign-up logic 403 displays a “Newsletters” GUI 2200 as depicted in FIG. 22.

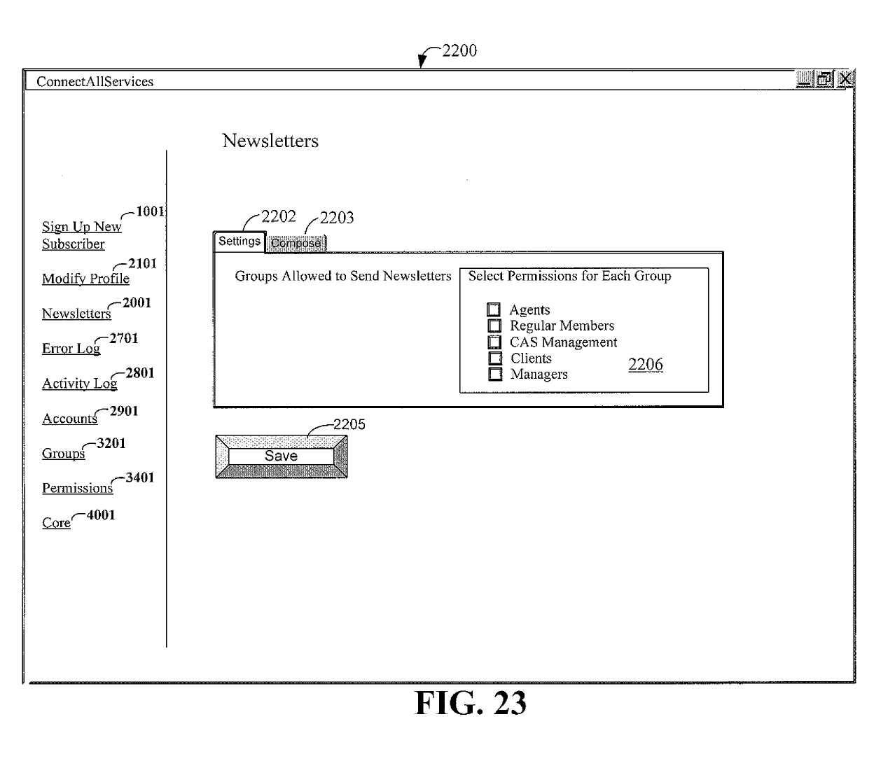

The GUI 2200 comprises two tabs 2202 and 2203 for “Settings” and “Compose,” respectively. FIG. 22 illustrates the “Settings” tab 2202 information, which comprises a link 2204 for selecting permissions for each group allowed to send a newsletter (not shown). FIG. 23 depicts a list 2206 that is displayed when the facilitator 103 selects link 2204. Thus, as an example, if “Regular Members” is checked, then this group is allowed to send newsletters.

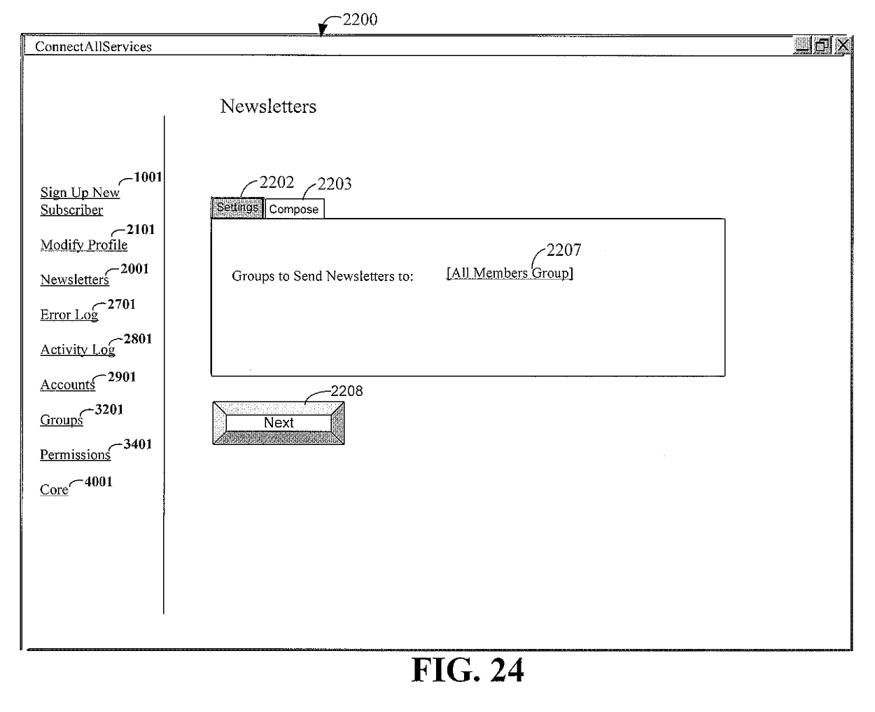

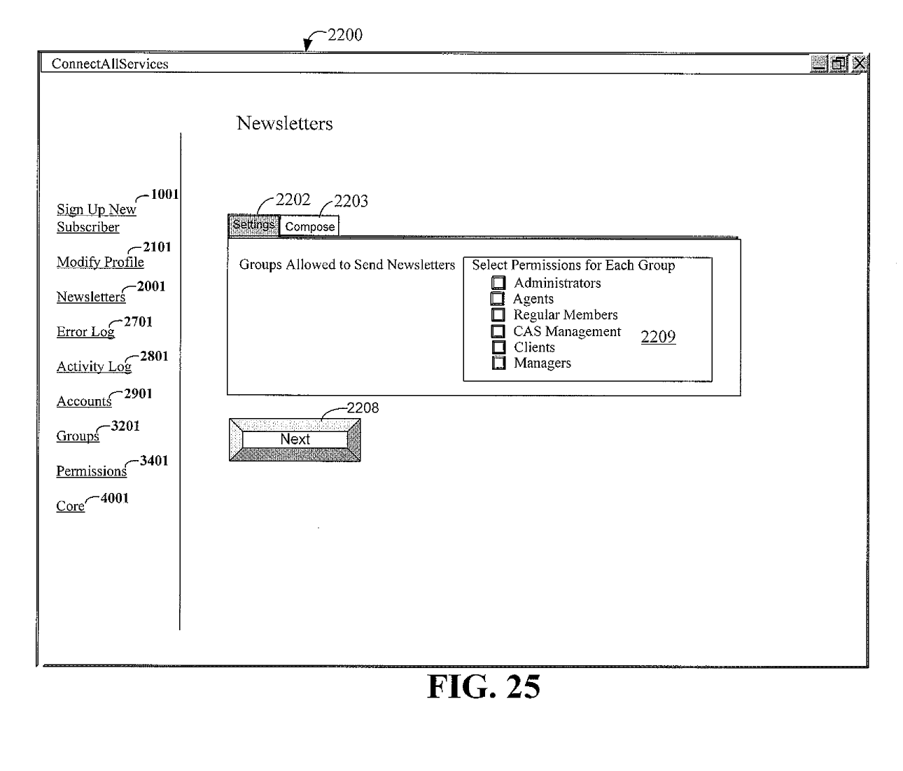

If the “Compose” tab 2203 is selected, the subscriber sign-up logic 403 displays an “All Member Groups” link 2207 shown in FIG. 24. When the facilitator 103 selects the link 2207, the subscriber sign-up logic 403 displays a list 2209 of “Groups” to whom newsletters are sent shown in FIG. 25. Thus, as an example, the facilitator 103 may check the “Regular Members” check box and select a “Next” button 2208 and all regular members can then send newsletters.

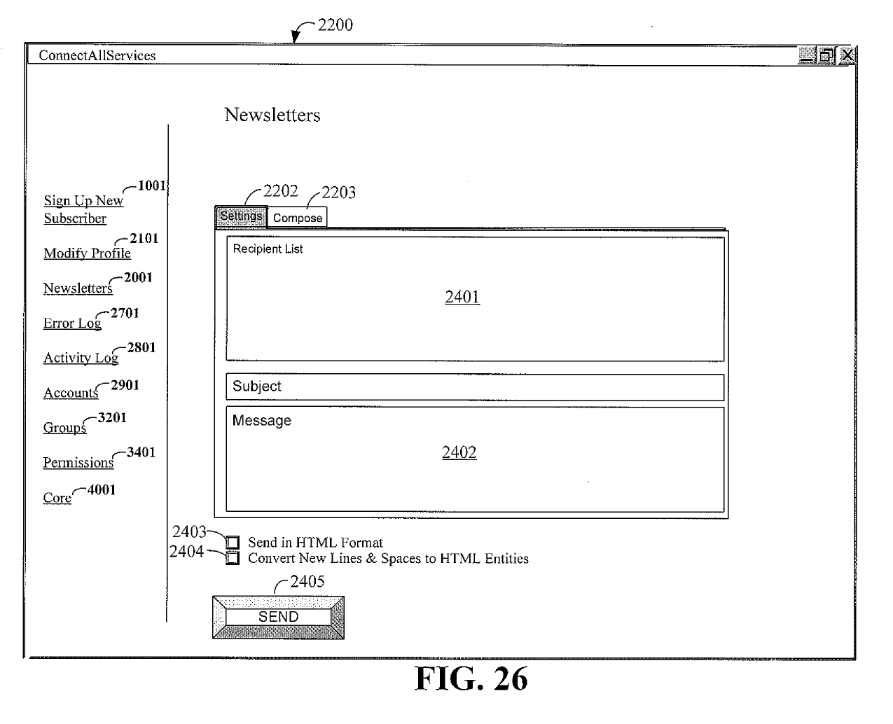

With reference to FIG. 26, upon selection of the “Next” push button 2208, the subscriber sign-up logic 403 displays the “Coupon” tab 2203, which includes a recipient list 2401 to which a newsletter is to be sent. Further, the subscriber sign-up logic 403 displays a “Message” box 2402 in which the facilitator 103 can type a message, and the facilitator 103 can select a format for sending the message, i.e., “HTML Format,” or “Convert New Lines and Spaces to HTML Entities” in check boxes 2403 and 2404, respectively. Once the facilitator 103 has completed the message, he/she selects a “Send” push button 2405. The subscriber sign-up logic 403 sends the message in box 2404 to those recipients listed in box 2401.

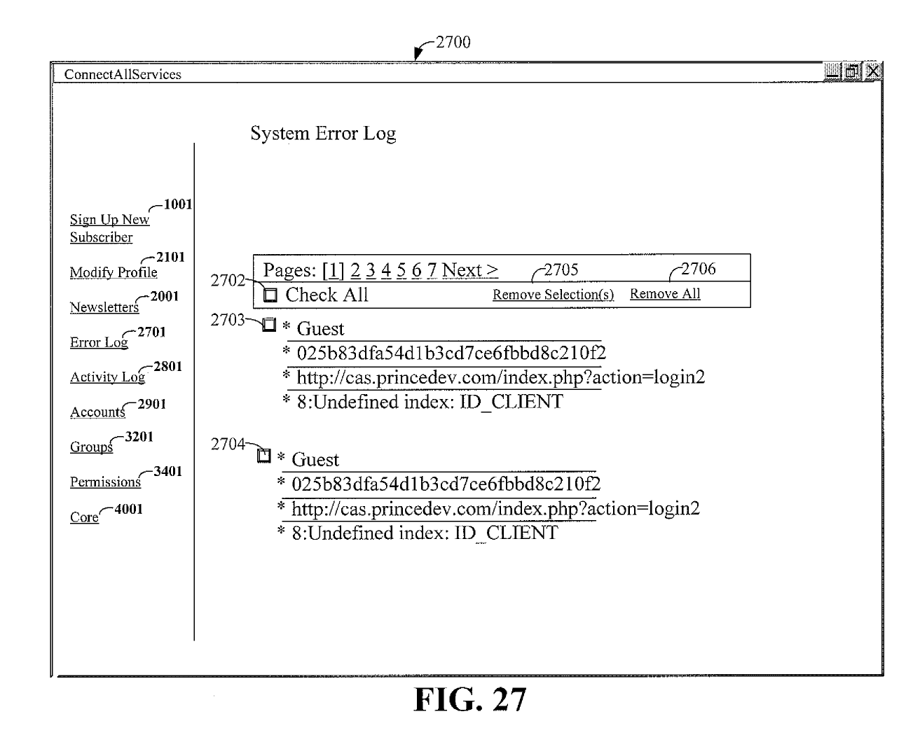

Upon selection of the “Error Log” link 2701, the subscriber sign-up logic 403 (FIG. 4) displays a “System Error Log” GUI 2700 depicted in FIG. 27. The GUI 2700 comprises a plurality of error identifications as related to the System 100 (FIG. 1) identified by check boxes 2703 and 2704. The facilitator 103 can select the “Remove Selection(s)” link 2505 to remove those entries having a check in the boxes 2703 and 2704. In addition, the facilitator 103 can select a “Remove All” link 2706 to remove all the entries. Further, the facilitator 103 can select a “Check All” check box 2702 and select all the entries associated with check boxes 2703 and 2704.

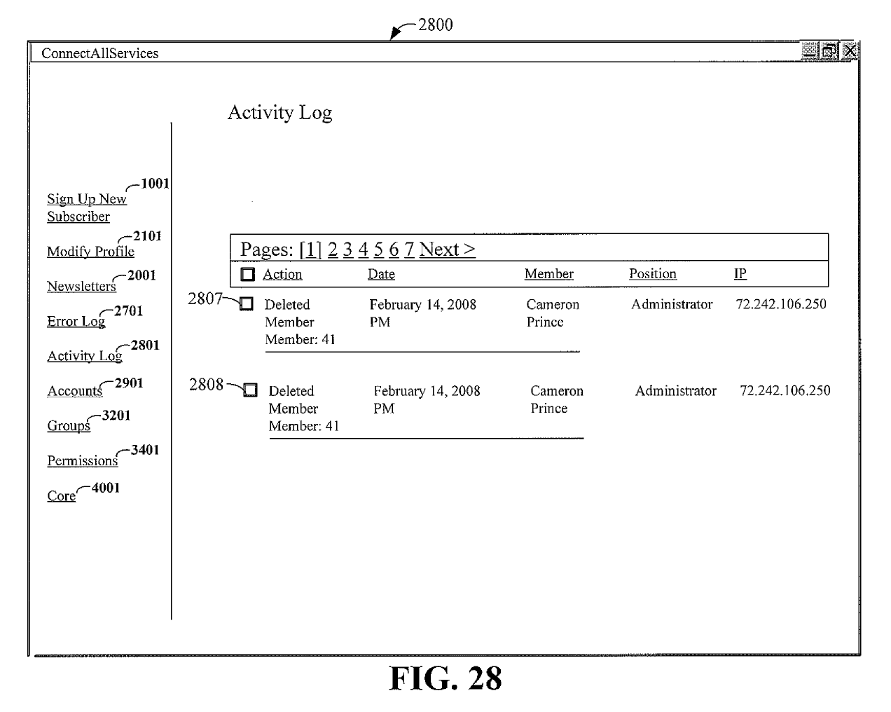

Upon selection of the “Activity Log” link 2801, the subscriber sign-up logic 403 (FIG. 4) displays an “Activity Log” GUI 2800 depicted in FIG. 28. The GUI 2800 comprises a plurality of activity identifications related to the system 100 (FIG. 1) identified by check boxes 2807 and 2808. The facilitator 103 can monitor activities of the various users on the system using GUI 2800.

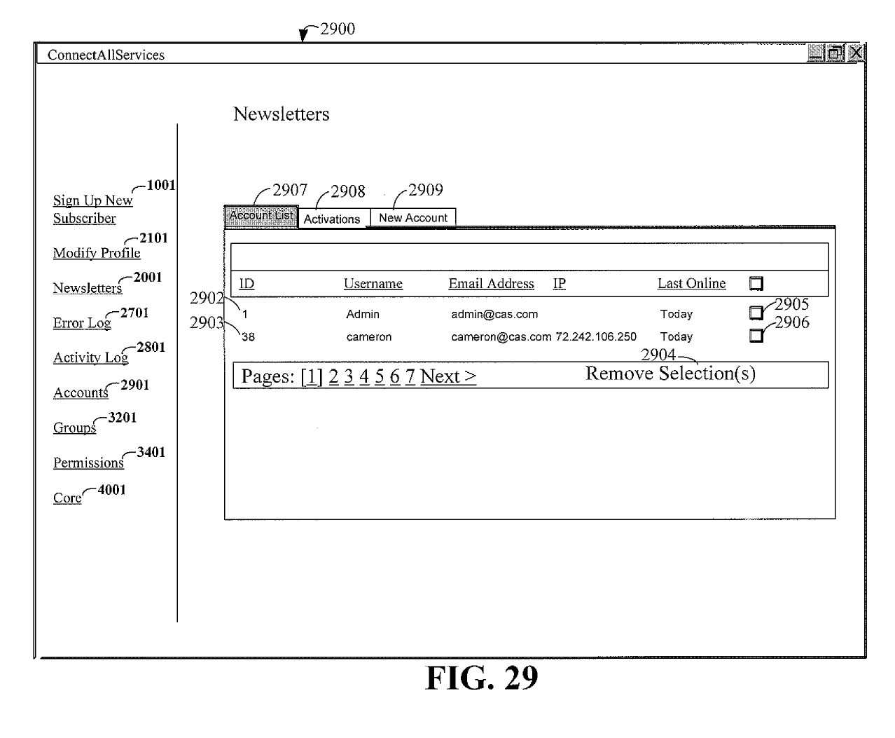

FIG. 29 depicts an “Accounts” GUI 2900 that the subscriber sign-up logic 403 (FIG. 4) displays when the facilitator 103 selects an “Accounts” link 2901. The “Accounts” GUI 2900 comprises three tabs, an “Accounts List” tab 2907, an “Activations” tab 2908, and a “New Account” tab 2909. FIG. 29 depicts the “Accounts List” tab 2907 including a list of accounts for “Admin” 2902 and “Cameron” 2903. Each listing 2902 and 2903 has a corresponding check box 2905 and 2906. If the facilitator desires to remove an account, he/she selects the appropriate check box 2905 and 2906 and selects a “Remove Selection(s)” link 2904.

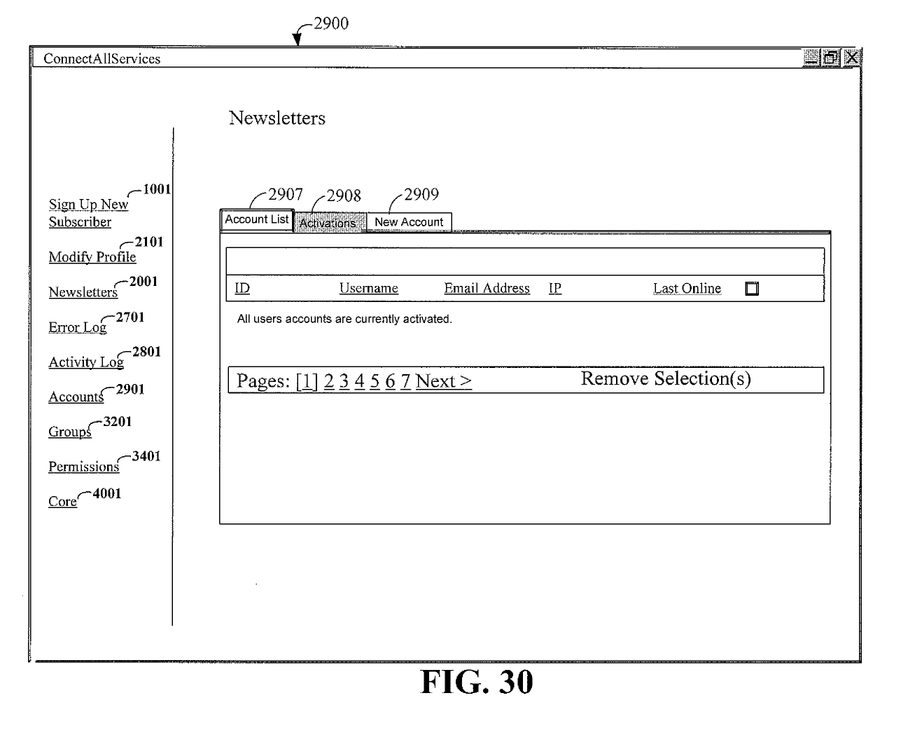

When the facilitator 103 selects the “Activations” tab 2908, the subscriber sign-up logic 403 displays information of GUI 2900 as shown with reference to FIG. 30. The GUI 2900 in FIG. 30 lists all the members who have not activated their accounts.

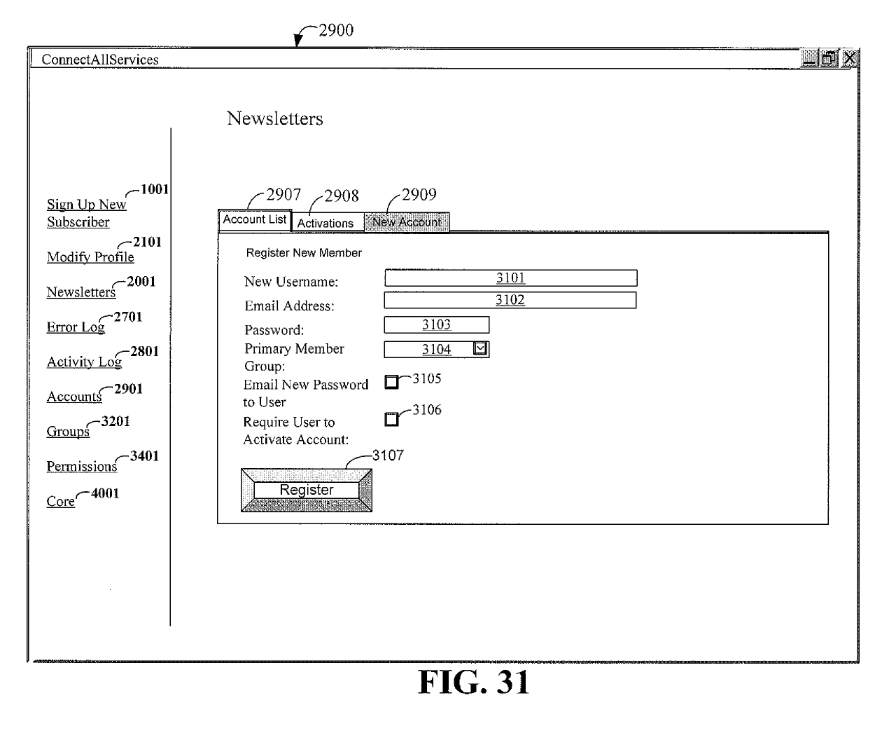

When the facilitator 103 selects the “New Account” tab 2909, the subscriber sign-up logic 403 displays information of GUI 2900 as shown with reference to FIG. 31. The GUI 2900 in FIG. 31 enables a facilitator 103 to set up a new account. In this regard, GUI 2900 comprises a “New Username” text field 3101 for entering data indicative of a new username. Further, GUI 2900 comprises an “Email Address” text field 3102, a “Password” text field 3103, a “Primary Member group” pull down menu 3104, a check box 3105 for checking if the password is emailed to the user, and a check box 3106 for checking if the user is to be required to activate account. Once all the information is entered, the facilitator 103 selects a “Register” push button 3107, and the user is registered with the system 100.

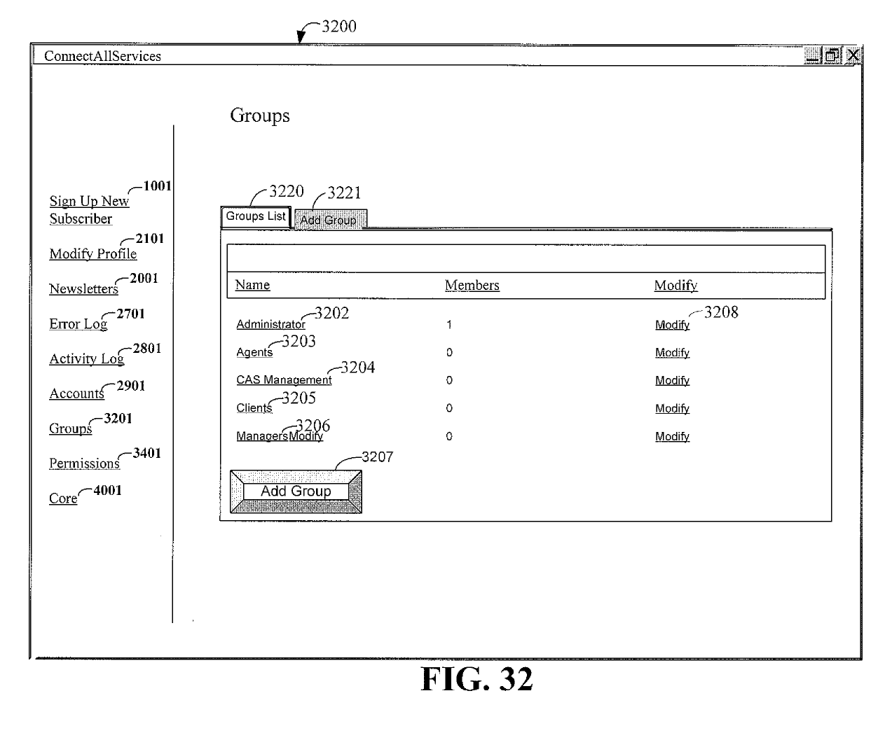

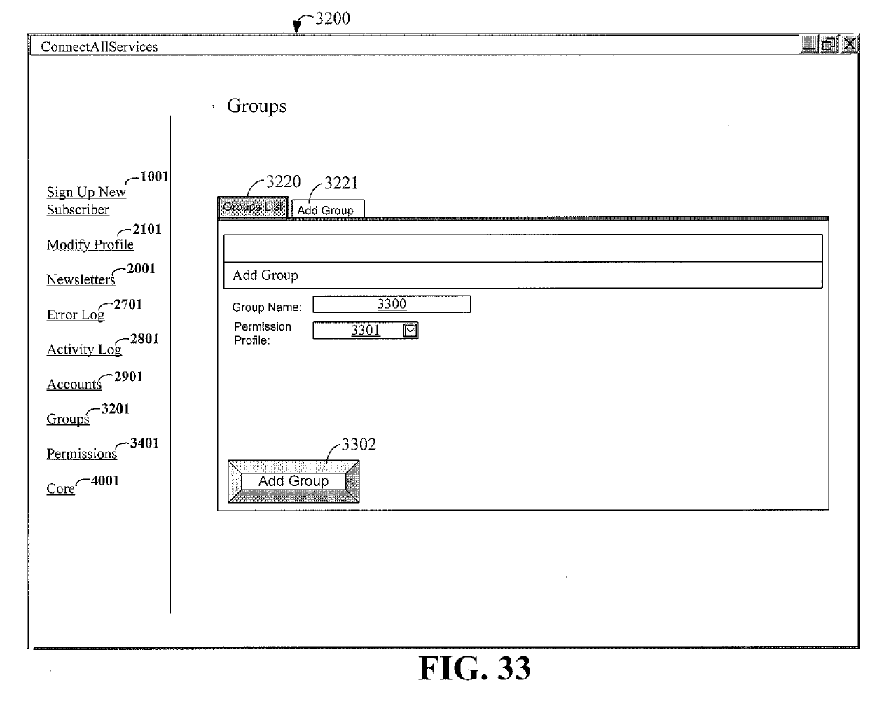

When the facilitator 103 selects the “Groups” link 3201, the subscriber sign-up logic 403 displays a “Groups” GUI 3200 as depicted in FIG. 32. GUI 3200 comprises a listing of one or more groups 3202-3206. The facilitator 103 can modify an existing group by selecting a “Modify” link 3208 under a “Groups List” tab 3220. In addition, the facilitator 103 can add a group by selecting an “Add Group” push button 3207. If selected, the subscriber sign-up logic 403 displays GUI 3200 as depicted in FIG. 33 under the “Add Group” tab 3221.

The facilitator 103 can add a group by entering identifying data in a “Group Name:” text field 3300 and give the group permissions by selecting permissions from the “Permission Profile:” pull down menu 3301. Once this information is entered, the facilitator 103 selects the “Add Group” push button 3302, and the group identified is added to the system 100.

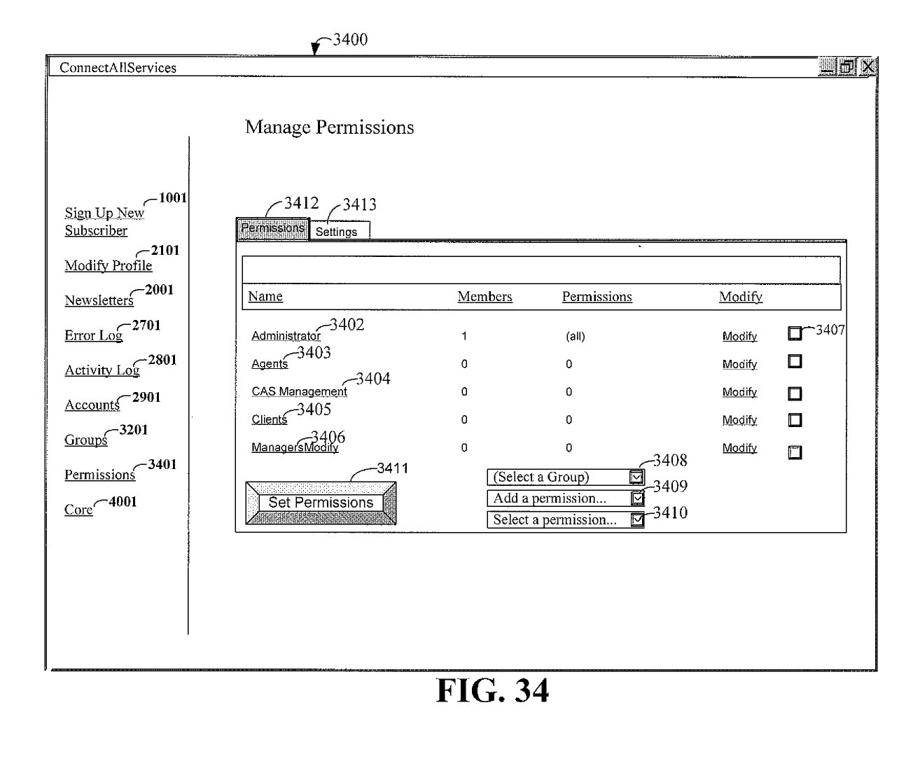

With reference to FIG. 34, the subscriber sign-up logic 403 (FIG. 4) displays a “Manage Permissions” GUI 3400 when the facilitator 103 selects the “Permissions” link 3401. From GUI 3400, the facilitator 103 can set permissions for group members under the “Permissions” tab 3412. Thus, the GUI 3400 has a plurality of members listed, identifiers 3402-3406. The facilitator 103 can modify any one of the groups identified by 3402-3406 by selecting a corresponding “Modify” check box 3407. In addition, the facilitator 103 can set permissions for the identified group from the “Set Permissions Like This Group” pull down menu 3408 or identify other permission schemes in the “Permissions Setting:” pull down menus 3409 and 3410. Once selection are made with reference to a group, the facilitator 103 selects a “Set Permissions” push button 3411, and the subscriber sign-up logic 403 sets the permissions accordingly.

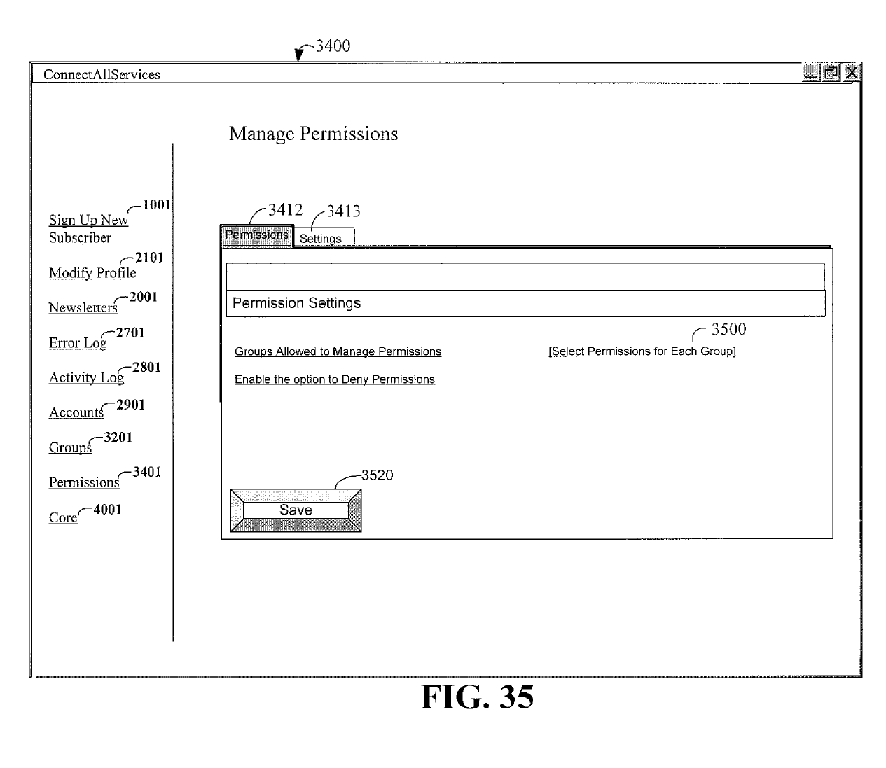

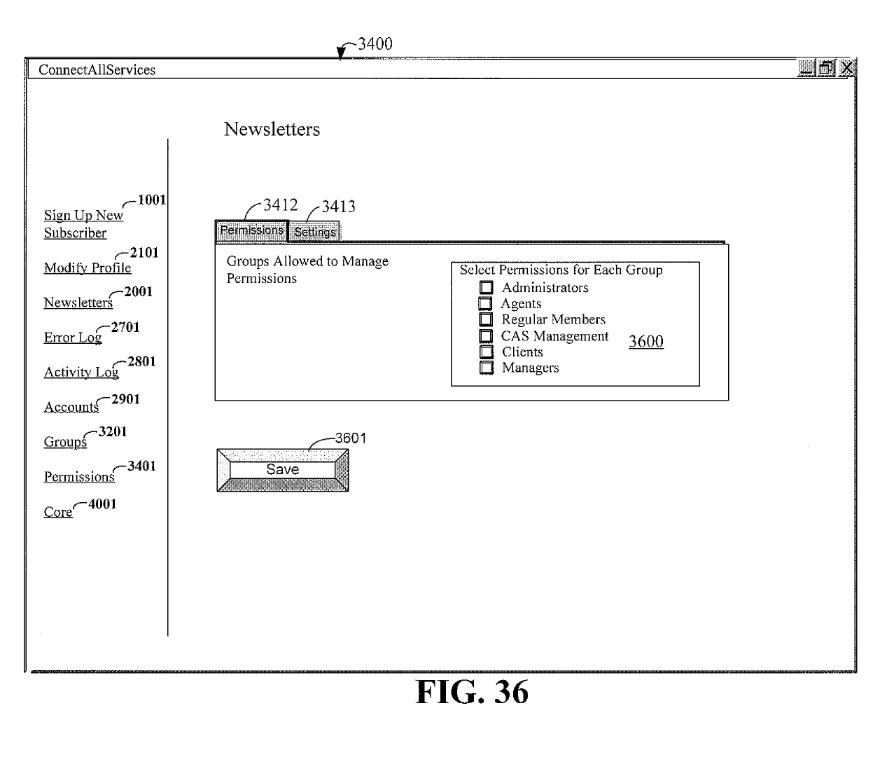

If the facilitator 103 selects the “Settings” tab 3413 from the GUI 3400, the subscriber sign-up logic 403 displays the “settings” tab information depicted in FIG. 35. From GUI 3400 of FIG. 35, the facilitator 103 can set who has permission to change the permissions of other groups. Thus, the facilitator 103 may select the “Select Permissions for each Group” link 3500 and the subscriber sign-up logic 403 displays a list 3600 depicted in FIG. 36. From this list, the facilitator 103 may change the permissions given, for example, “Regular Members,” “Agents,” or the like and select a “Save” push button 3601 which saves the changed data.

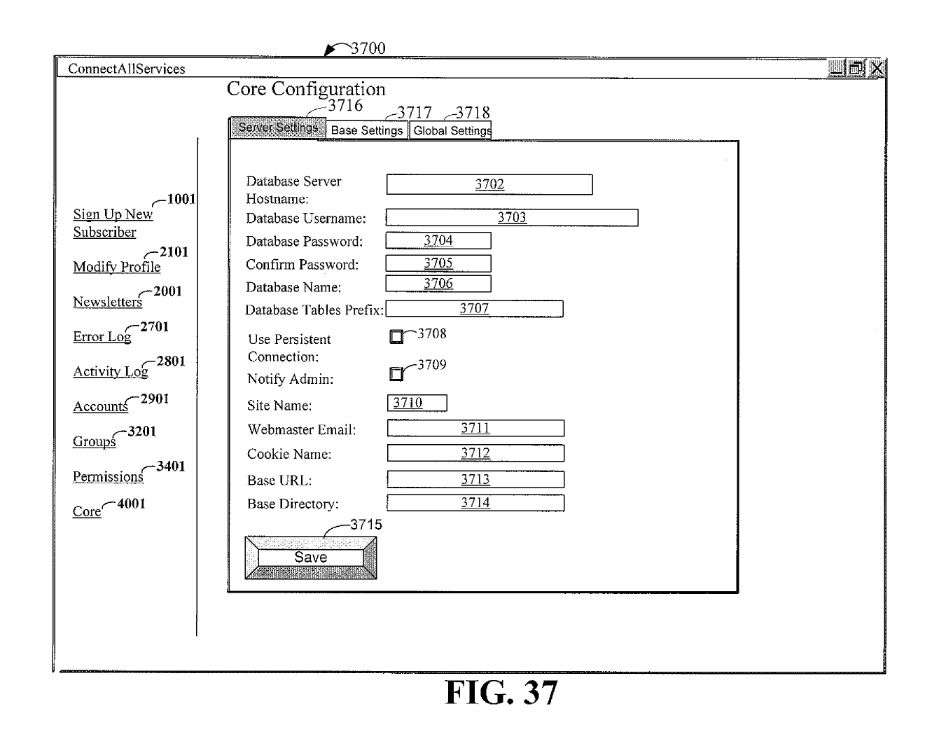

If the facilitator 103 (FIG. 1) selects the “Core” link 4001 depicted in FIG. 37, the subscriber sign-up logic 403 displays a “Core Configuration” GUI 3700 under a “Server Settings” tab 3716. Under “Server Settings” the facilitator 103 can change information related to the private computing device 102 (FIG. 2). Notably, the facilitator 103 can change the “Database Server Hostname” in text field 3702, the “Database Username” in text field 3703, the “Database Password” in text field 3704 and confirmation of the password in text field 3705, the “Database Name” in text field 3706, and the “Database Tables Prefix” in text field 3707. Additionally, the facilitator 103 can select “Use Persistent Connection” in check box 3708 and “Notify Admin of Database Connection Errors” by selecting check box 3709. Furthermore, the facilitator 103 can edit the “Site Name” using text field 3710, the Webmaster Email Address using text field 3711, the “Cookie Name” using text field 3712, the “Base URL” using text field 3713, and the “Base Directory” in text field 3714. Once the changes are made, the facilitator 103 can select “Save” push button 3715 to modify the above-referenced parameters.

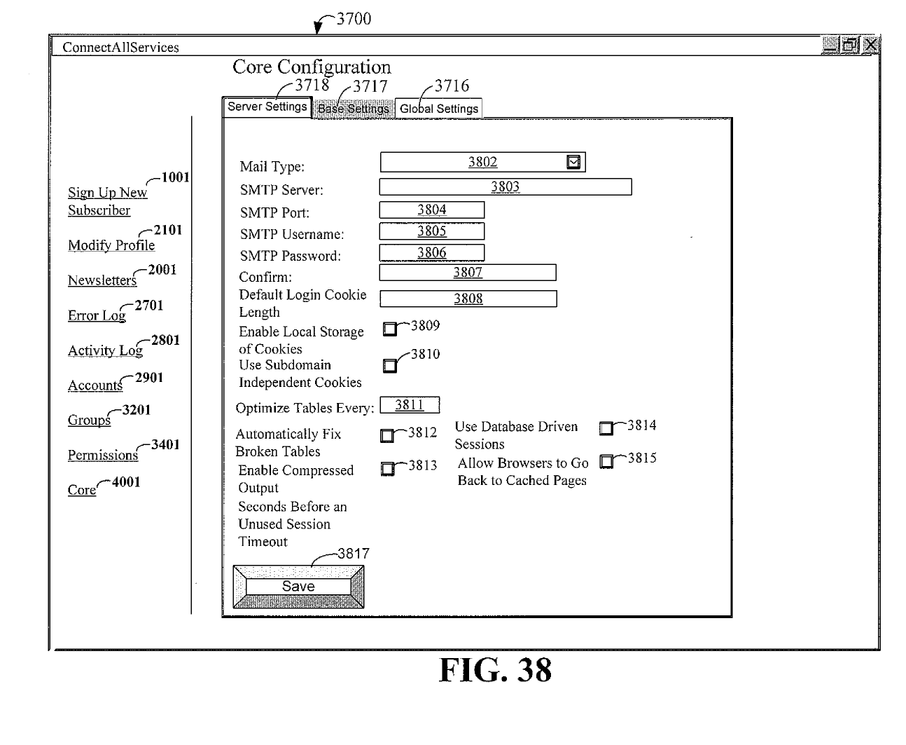

When the facilitator 103 selects the “Base Settings” tab 3717, the subscriber sign-up logic 403 displays the “Base Settings” information depicted in FIG. 38. The “Base Settings” allow the facilitator 103 to change the low level server settings related to the private computing device 203 (FIG. 2). In this regard, the facilitator 103 can edit the “Mail Type” using pull down menu 3802, the “SMTP Server” by editing text field 3803, the “SMTP Port” by editing text field 3804, the “SMTP Username” by editing text field 3805, and the “SMTP Password” by editing text field 3806 and confirmation of the password in text field 3807. In addition, the facilitator 103 can edit the “Default Login Cookie Length” using text field 3808, the “Enable Local Storage Of Cookies” by editing text field 3809, the “Use Sub domain Independent Cookies” by editing text field 3810, and the “Optimize Tables Every” by editing text field 3811. Further text fields in the GUI of FIG. 38 include an “Automatically Fix Broken Tables” check box 3812, an “Enable Compressed Output” check box 3813, a “Use Database Driven Sessions” check box 3814, an “Allow Browsers to Go Back to Cached Tables” check box 3815, and a “Seconds Before an Unused Session Timeout” check box 3816. Once all changes desired are made, the facilitator 103 selects the “Save” push button 3817, and the subscriber sign-in logic 403 saves the modifications in the system 100.

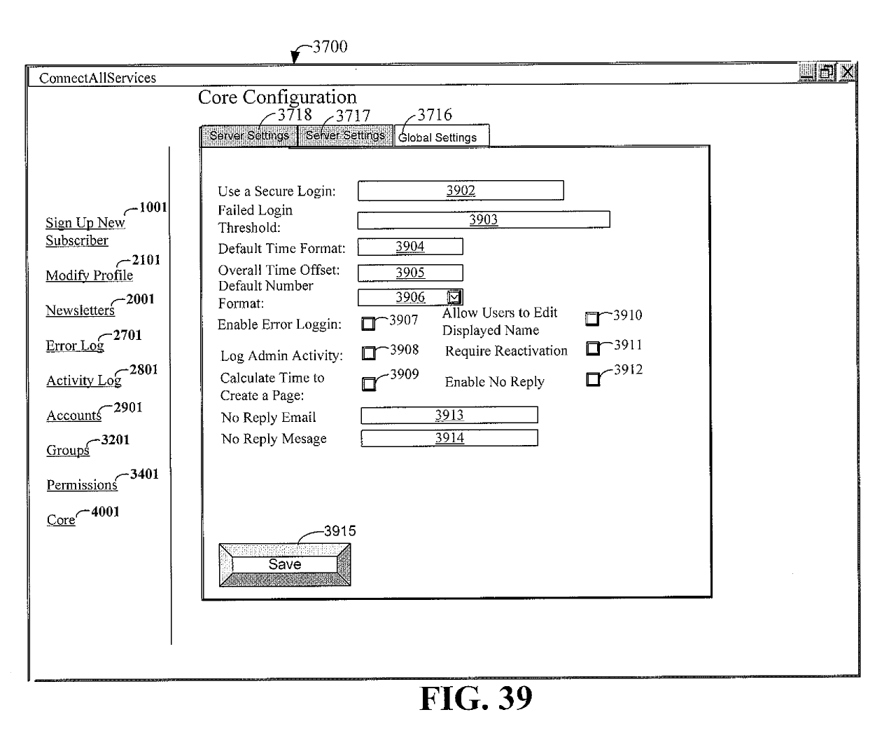

When the facilitator 103 selects the “Global Setting” tab 3718, the subscriber sign-up logic 403 displays the “Global Settings” information depicted in FIG. 39. This display allows the facilitator 103 to change additional low level server settings related to the private computing device 203 (FIG. 2). In this regard, the facilitator 103 can edit the “Use a Secure Login” using pull down menu 3902, the “Failed Login Threshold” by editing text field 3903, the “Default Time Format” by editing text field 3904, the “Overall Time Offset” by editing text field 3905, and the “Default Number Format” by editing pull down menu 3906. In addition, the facilitator 103 can “Enable Error Logging” using check box 3907, “Log Admin Activity” by selecting check box 3908, “Calculate Time to Create Each Display” by selecting check box 3909, and “Allow Users to Edit Displayed Name” by selecting check box 3910. Further, text fields in the GUI of FIG. 39 include a “Require Reactivation” check box 3911, an “Enable No Reply Email” check box 3912, a “No Replay Email Address” text field 3913, and a “No Reply Message” text field 3914. Once all changes desired are made, the facilitator 103 selects the “Save” push button 3915, and the subscriber sign-in logic 403 saves the modifications in the system 100.

In one embodiment of the present disclosure as described herein, the facilitator 103 (FIG. 1) is a leasing agent, apartment manager, real-estate agent or broker, or the like. Leasing agents or apartment managers work for “clients,” which are property owners, rental companies, real estate firms, or the like. In such an embodiment, the system 100 (FIG. 1) can be set up such that when the facilitator 103 signs up a subscriber 102 for a particular service, the subscriber sign-up logic 403 (FIG. 4) of the system 100 tracks the particular service selected, the identity of the facilitator 103, and/or the identity of the client for whom the facilitator 103 works.

Furthermore, in such an embodiment, a service provider pays monies, in the form of bounties, to the owner of the system 100. This bounty, or a portion thereof, can be paid to the client and/or the facilitator 103 that actually signed the subscriber up for the particular service. Thus, the client and/or the facilitator receive a “commission” on the sign up.

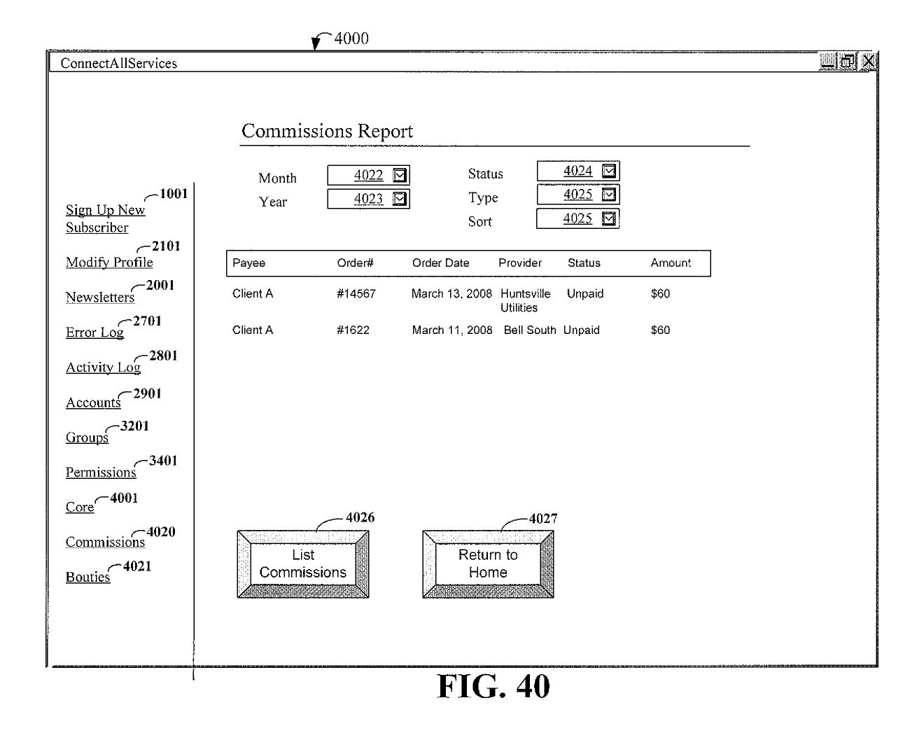

FIG. 40 depicts an exemplary “Commissions Report” GUI 4000 in accordance with an embodiment of the present disclosure. In such an embodiment, the GUI 4000 comprises pull down menus 4022-4025 for entering “Month,” “Year,” “Status,” “Type,” and “Sort” data. The subscriber sign-up logic 403 searches the bounty/commissions data 480 (FIG. 4) and displays to the GUI 4000 those entries that match the data entered in the pull down menus 4022-4025 and commissions outstanding, paid, or unpaid related to the data entered.

As examples, the status menu 4024 allows the facilitator 103 or other user, e.g., an administrative person, a client or a manager, to enter an indicator of “Paid.” Thus, if the facilitator has been paid a commission for a sign-up made by the facilitator 103, the subscriber sign-up logic 403 displays in the GUI 4000 data indicative of the “Payee,” e.g., “Client A,” an “Order #,” e.g., “#14567,” and “Order Date,” e.g., “Mar. 13, 2008,” a “Provider,” e.g., “Huntsville Utilities,” a “Status,” e.g., “Unpaid,” and an “Amount,” e.g., “$60.00.”

“List Commissions” push button 4026, when selected, lists all commissions on the system 100 (FIG. 1). A “Return to Home” push button 4027 when selected, displays GUI 1000 (FIG. 10).

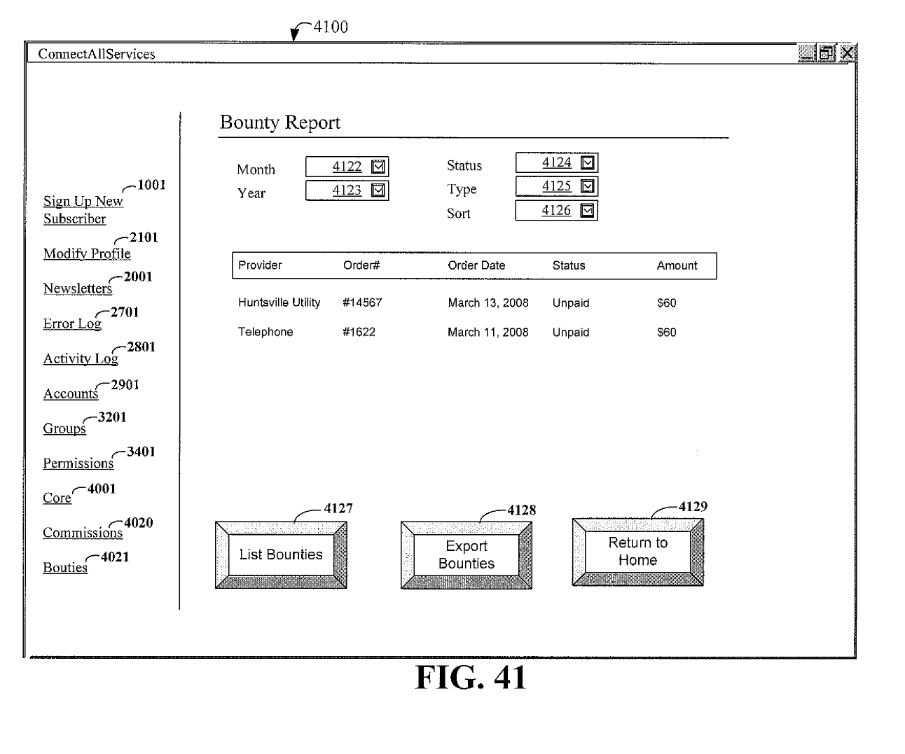

FIG. 41 depicts an exemplary “Bounty Report” GUI 4100 in accordance with an embodiment of the present disclosure. In such an embodiment, the GUI 4100 comprises pull down menus 4122-4125 for entering “Month,” “Year,” “Status,” “Type,” and “Sort” data. The subscriber sign-up logic 403 searches the bounty/commissions data 480 (FIG. 4) and displays to the GUI 4100 those entries that match the data entered in the pull down menus 4122-4125 and bounties outstanding, paid, or unpaid related to the data entered.

As examples, the “Month” menu 4122 allows the facilitator 103 or other user, e.g., an administrative person, a client or a manager, to enter an indicator of “March.” Thus, if a client is owed or has been paid a bounty from a service provider for a sign-up made by a facilitator 103, the subscriber sign-up logic 403 displays in the GUI 4100 data indicative of the “Provider,” e.g., “Huntsville Utilities,” an “Order #,” e.g., “#14567,” and “Order Date,” e.g., “Mar. 13, 2008,” a “Provider,” e.g., “Huntsville Utilities,” a “Status,” e.g., “Unpaid,” and an “Amount,” e.g., “$60.00.”

A “List Bounties” push button, when selected, lists all bounties in data 480. In addition, an “Export Bounties” push button 4128 exports data 480 into another format, e.g., Excel. A “Return to Home” push button 4129 displays GUI 1000 (FIG. 10).

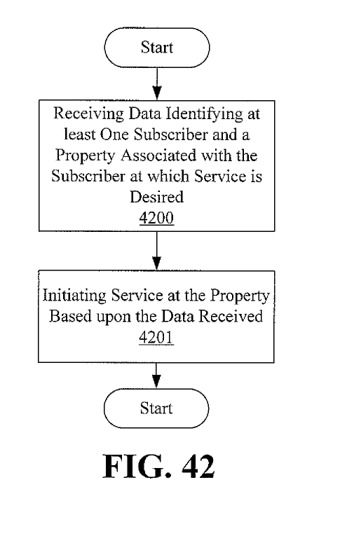

FIG. 42 is a flowchart illustrating exemplary functionality and architecture of the subscriber sign-up logic 403 (FIG. 4). The subscriber sign-up logic 403 receives data identifying at least one subscriber 102 (FIG. 1) and a property associated with the subscriber 102 at which service is desired, as indicated in step 4000.

In step 4001, the subscriber sign-up logic 403 initiates service with at least one service provider. To initiate service, the subscriber sign-up logic 403 communicates with at least one of the utility computing device 105 (FIG. 1), the telephone computing device 106 (FIG. 1), or the satellite computing device 107 (FIG. 1).

Now, therefore, the following is claimed:

1. A system comprising:
a communication device for communicating with a service provider; and
logic configured receive data identifying at least a subscriber and a property at which the subscriber desires service from the service provider, the logic further configured to initiate service at the property based upon the data via the communication device.

2. The system of claim 1, wherein the logic is further configured to receive a verification that service sign-up is complete and display the verification to a display device.

3. The system of claim 1, further comprising a public computing device communicatively coupled to a private computing device such that the private computing device transmit to the public computing device, but the public computing device could not transmit to the private computing device.

4. The system of claim 3, wherein the data identifying at least the subscriber and the property at which the subscriber desires service is stored on the private computing device.

5. The system of claim 4, wherein the logic is further configured to encrypt the data and store a public key used to encrypt the data and the encrypted data on the public computing device.

6. The system of claim 5, wherein a private key used to encrypt the data is stored on the private computing device.

7. The system of claim 6, wherein the logic is further configured to transmit the public key and the encrypted data to a service provider computing device.

8. The system of claim 7, wherein the logic is further configured to transmit the private key separate from the public key and encrypted data to the service provider computing device.

9. The system of claim 1, wherein the logic is further configured to store acceptable credit data indicative a service provider and a credit threshold associated with the service provider.

10. The system of claim 1, wherein the logic is further configured to request credit score data from a credit-checking computing device for the subscriber.

11. The system of claim 10, wherein the logic is further configured to compare credit score data with the acceptable credit data to determine whether to offer the service provider to the subscriber.

12. A method, comprising:
receiving data identifying at least one subscriber and a property associated with the subscriber at which the subscriber desires service; and
initiating service at the property based upon the data via a communication device.

13. The method of claim 12, further comprising the steps of:
receiving a verification that service sign-up is complete; and
displaying the verification to a display device.

14. The method of claim 12, further comprising the step of storing the data identifying at least the subscriber and the property at which the subscriber desires service on a private computing device.

15. The method of claim 14, further comprising the step of encrypting using a public key and a private key.

16. The method of claim 15, further comprising the step of storing the public key and the encrypted data on a public computing device.

17. The method of claim 16, further comprising the step of storing the private key on the private computing device.

18. The method of claim 17, further comprising the step of transmitting the public key and the encrypted data to a service provider computing device.

19. The method of claim 18, further comprising the step of transmitting the private key separate from the public key and encrypted data to the service provider computing device.

19. The method of claim 12, further comprising the step of storing acceptable credit data indicative a service provider and a credit threshold associated with the service provider.

20. The method of claim 19, further comprising the step of requesting credit score data from a credit-checking computing device for the subscriber.

21. The method of claim 20, further comprising the step of comparing the credit score data with the acceptable credit data to determine whether to offer the service provider to the subscriber.
